(19) United States
(12) Patent Application Publication
(10) Pub. No.: US 2026/0252592 A1
(43) Pub. Date: Aug. 27, 2026

(54) SYSTEM

(71) Applicant: SoftBank Group Corp., Tokyo (JP)

(72) Inventor: Masanori TADA, Tokyo (JP)

(73) Assignee: SoftBank Group Corp., Tokyo (JP)

(21) Appl. No.: 19/536,229

(22) Filed: Feb. 11, 2026

(30) Foreign Application Priority Data
Feb. 21, 2025 (JP) 2025-027038

(51) Int. Cl. G06F 16/31

(52) U.S. Cl. CPC G06F 16/313

(57) ABSTRACT

The system according to the embodiment comprises an analysis unit, a display unit, a visualization unit, and a storage unit. The analysis unit analyzes conversation content in real time. The display unit displays the content analyzed by the analysis unit in a tabular format. The visualization unit visualizes the progress of a discussion. The storage unit stores the history of the discussion.

### CROSS-REFERENCE TO RELATED APPLICATION

The present application claims priority to and incorporates by reference the entire contents of Japanese Patent Application No. 2025-027038 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, real-time analysis of conversation content and visualization of the progress of a discussion have not been sufficiently performed, leaving room for improvement.

### SUMMARY OF THE INVENTION

The system according to the embodiment comprises an analysis unit, a display unit, a visualization unit, and a storage unit. The analysis unit analyzes conversation content in real time. The display unit displays the content analyzed by the analysis unit in a tabular format. The visualization unit visualizes the progress of a discussion. The storage unit stores the history of the discussion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

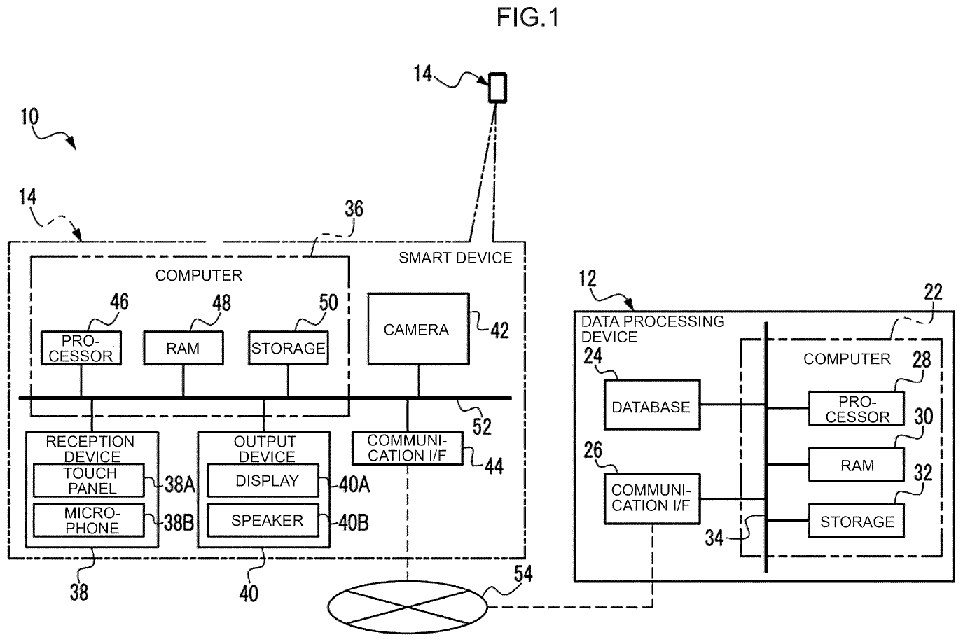

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

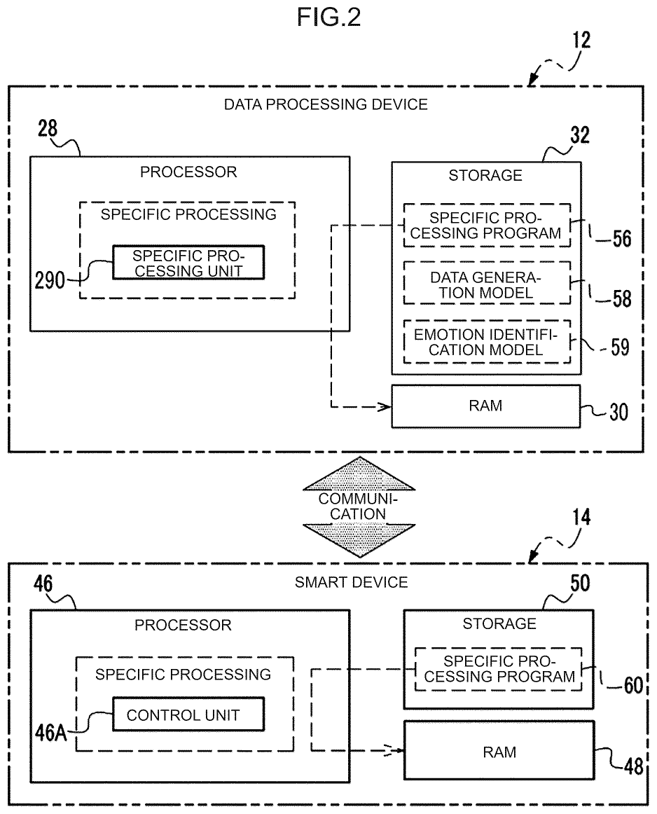

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The online discussion support system according to the embodiment of the present invention is a system that analyzes conversation content in real time and processes it into various forms (tabular format, graphs, images) for display on monitors or via AR. This online discussion support system analyzes conversation content in real time and instantly displays comparative content such as Pattern A and Pattern B in a tabular format. As a result, it becomes easier to compare merits and demerits, instantly identify whether the discussion is MECE (Mutually Exclusive, Collectively Exhaustive), and recognize areas that have not been sufficiently discussed. Furthermore, it is possible to resume discussions that were interrupted by other topics at a later time. For example, to analyze conversation content in real time, speech recognition technology is used to convert conversation into text. Next, the text-converted conversation content is analyzed using natural language processing technology to understand the content of the discussion. For instance, if there is a conversation such as “Pattern A is such and such, Pattern B is such and such,” the system extracts the content of Pattern A and Pattern B and displays it in a tabular format. Additionally, to visualize the progress of the discussion, the system displays the structure of the discussion using graphs or images. For example, a graph is created for each discussion topic to visually indicate how much each topic has been discussed. This allows for checking the balance of the discussion and identifying areas that have not been sufficiently discussed. Moreover, even if the discussion is interrupted by another topic, the system saves the history of the discussion, enabling it to be resumed later. For example, even if the discussion shifts to another topic midway, the system records the point of interruption, allowing the discussion to continue from that point upon resumption. Through this system, the efficiency of online discussions is improved, enabling more effective discussions. Thus, the online discussion support system can improve the efficiency of online discussions by analyzing, displaying, visualizing, and saving conversation content in real time. Specifically, the online discussion support system is composed of multiple modules such as a speech recognition unit, a natural language processing unit, a comparison extraction unit, a visualization unit, a history management unit, and a display control unit. The speech recognition unit receives conversation audio data (e.g., 16 kHz, 16 bit, monaural PCM format time-series tensor) as input, performs spectrogram conversion and noise reduction (band-pass filter, spectral subtraction, etc.), and then converts speech to text using a deep neural network (e.g., convolutional recurrent network, speech recognition model using CTC loss function). Examples of input include uttered speech such as “Plan A has low cost” and “Plan B is easy to implement.” The output is a sequence of characters (e.g., “Plan A has low cost.”). The natural language processing unit receives the text data output from the speech recognition unit and sequentially performs morphological analysis (e.g., word segmentation, part-of-speech tagging), syntactic analysis (dependency parsing), semantic analysis (context vectorization using pre-trained language models such as BERT), topic extraction (LDA or clustering), and comparison expression detection (pattern extraction using rule-based or Transformer-type models). Examples of input include text such as “Plan A has low cost. Plan B is easy to implement.” The output is structured data such as “Plan A: low cost” and “Plan B: easy implementation,” as well as item labels and value pairs for comparison tables. The comparison extraction unit formats the extracted comparison items into a tabular format (two-dimensional array, JSON structure, etc.) and sends them to the display control unit. The visualization unit aggregates metadata such as the progress of the discussion, number of utterances per topic, utterance time, emotion scores, etc., and applies various visualization methods such as bar graphs (number of utterances per topic), pie charts (distribution of discussion time), and network diagrams (relationships between speakers). For example, if Topic A is discussed 30% and Topic B 70% of the time, the graph clearly indicates this ratio. The history management unit saves the content of each utterance, speaker, timestamp, analysis results, visualization data, etc., for each turn of the discussion in a database (e.g., NoSQL type, time-series DB) in chronological order. The storage format can be selected from JSON, CSV, images (SVG, PNG), etc. The display control unit uses HTML5, CSS3, WebGL, etc., to render tables, graphs, and images in real time on the user interface (web browser, AR glasses, etc.), and dynamically switches the display content according to user operations (e.g., topic selection, time-series scrolling). Examples of AI model input/output include input to the speech recognition model as “16 kHz, 5 seconds of PCM audio data,” output as text such as “Plan B is easy to implement,” input to the natural language processing model as “Plan A has low cost. Plan B is easy to implement,” and output as comparison table data such as “Plan A: low cost” and “Plan B: easy implementation.” In subsequent processing, the comparison table data is rendered in tabular format by the display unit, and the visualization data is passed to the graph rendering module. This series of processes, unlike conventional manual work (minutes creation, comparison table creation, discussion visualization), is realized by combining computer-specific technical methods such as feature extraction in high-dimensional vector space, semantic analysis by neural networks, rule-based comparison item extraction, and real-time data flow control, resulting in significant improvements in the accuracy and speed of discussion visualization, comparison, and resumption support. Specific application fields include online meetings in companies, discussion classes in educational settings, remote medical conferences, policy-making workshops, and AI-based automatic minutes generation services.

The online discussion support system according to the embodiment comprises an analysis unit, a display unit, a visualization unit, and a storage unit. The analysis unit analyzes conversation content in real time. For example, the analysis unit can convert conversation into text using speech recognition technology. The speech recognition technology may use, for example, a speech recognition algorithm based on deep learning. The speech recognition technology receives conversation audio data as input and outputs text data. Next, the analysis unit analyzes the text-converted conversation content using natural language processing technology. The natural language processing technology may include, for example, morphological analysis, grammatical analysis, and semantic analysis. The natural language processing technology receives text data as input and outputs analysis results. The display unit displays the content analyzed by the analysis unit in a tabular format. For example, the display unit extracts the content of Pattern A and Pattern B and displays it in a tabular format. The display unit can create tables using HTML or CSS, for example. The display unit receives analysis results as input and outputs tables. The visualization unit visualizes the progress of the discussion. For example, the visualization unit creates graphs for each discussion topic and visually indicates how much each topic has been discussed. The visualization unit can use bar graphs, pie charts, line graphs, etc. The visualization unit receives analysis results as input and outputs graphs. The storage unit stores the history of the discussion. For example, the storage unit saves the history of the discussion in a database and provides information for resuming the discussion later. The storage unit receives analysis results as input and outputs stored data. Thus, the online discussion support system according to the embodiment can improve the efficiency of online discussions by analyzing, displaying, visualizing, and saving conversation content in real time. Specifically, the online discussion support system is composed of multiple modules such as a speech recognition unit, a natural language processing unit, a comparison extraction unit, a visualization unit, a history management unit, and a display control unit. The speech recognition unit receives conversation audio data (e.g., 16 kHz, 16 bit, monaural PCM format time-series tensor) as input, performs spectrogram conversion and noise reduction (band-pass filter, spectral subtraction, etc.), and then converts speech to text using a speech recognition model based on convolutional recurrent networks and CTC loss function. Examples of input include uttered speech such as “Plan A has low cost” and “Plan B is easy to implement.” The output is a sequence of characters (e.g., “Plan A has low cost.”). The natural language processing unit receives the text data output from the speech recognition unit and sequentially performs morphological analysis (word segmentation, part-of-speech tagging), syntactic analysis (dependency parsing), semantic analysis (context vectorization using pre-trained language models such as BERT), topic extraction (LDA or clustering), and comparison expression detection (pattern extraction using rule-based or Transformer-type models). Examples of input include text such as “Plan A has low cost. Plan B is easy to implement.” The output is structured data such as “Plan A: low cost” and “Plan B: easy implementation,” as well as item labels and value pairs for comparison tables. The comparison extraction unit formats the extracted comparison items into a tabular format (two-dimensional array, JSON structure, etc.) and sends them to the display control unit. The visualization unit aggregates metadata such as the progress of the discussion, number of utterances per topic, utterance time, emotion scores, etc., and applies various visualization methods such as bar graphs (number of utterances per topic), pie charts (distribution of discussion time), and network diagrams (relationships between speakers). For example, if Topic A is discussed 30% and Topic B 70% of the time, the graph clearly indicates this ratio. The history management unit saves the content of each utterance, speaker, timestamp, analysis results, visualization data, etc., for each turn of the discussion in a database (NoSQL type, time-series DB) in chronological order. The storage format can be selected from JSON, CSV, images (SVG, PNG), etc. The display control unit uses HTML5, CSS3, WebGL, etc., to render tables, graphs, and images in real time on the user interface (web browser, AR glasses, etc.), and dynamically switches the display content according to user operations (e.g., topic selection, time-series scrolling). Examples of AI model input/output include input to the speech recognition model as “16 kHz, 5 seconds of PCM audio data,” output as text such as “Plan B is easy to implement,” input to the natural language processing model as “Plan A has low cost. Plan B is easy to implement,” and output as comparison table data such as “Plan A: low cost” and “Plan B: easy implementation.” In subsequent processing, the comparison table data is rendered in tabular format by the display unit, and the visualization data is passed to the graph rendering module. This series of processes, unlike conventional manual work (minutes creation, comparison table creation, discussion visualization), is realized by combining computer-specific technical methods such as feature extraction in high-dimensional vector space, semantic analysis by neural networks, rule-based comparison item extraction, and real-time data flow control, resulting in significant improvements in the accuracy and speed of discussion visualization, comparison, and resumption support. Specific application fields include online meetings in companies, discussion classes in educational settings, remote medical conferences, policy-making workshops, and AI-based automatic minutes generation services.

The analysis unit can convert conversation into text using speech recognition technology. The speech recognition technology may include, for example, a speech recognition algorithm based on deep learning. The speech recognition technology receives conversation audio data as input and outputs text data. For example, the speech recognition technology can analyze conversation audio data in real time and convert it into text data. Additionally, the speech recognition technology can perform noise reduction and preprocessing of audio. For example, the speech recognition technology removes noise from audio data using a noise reduction filter and performs preprocessing of the audio. Furthermore, the speech recognition technology can extract feature quantities from audio data and input them into the speech recognition algorithm. For example, the speech recognition technology extracts Mel-frequency cepstral coefficients (MFCC) from audio data and inputs them into the speech recognition algorithm. Thus, by using speech recognition technology, conversation can be converted into text in real time. Some or all of the above-described processing in the analysis unit may be performed using AI, or may be performed without using AI. For example, the analysis unit can input audio data into a generative AI and have the generative AI generate text data. Specifically, the analysis unit receives time-series tensor data in 16 kHz, 16 bit, monaural PCM format as input for speech recognition processing. The analysis unit first performs spectrogram conversion and applies noise reduction processing such as band-pass filtering and spectral subtraction. The analysis unit extracts Mel-frequency cepstral coefficients (MFCC), zero-crossing rate, spectral energy, etc., as audio features after preprocessing, and inputs these as feature vectors into the speech recognition model. The analysis unit may employ a hybrid model combining convolutional neural networks (CNN) and recurrent neural networks (RNN), or a speech recognition architecture using a CTC (Connectionist Temporal Classification) loss function as the speech recognition model. For example, the analysis unit uses uttered speech such as “Plan A has low cost” and “Plan B is easy to implement” as input examples, and generates a sequence of characters such as “Plan A has low cost.” as output. In training the speech recognition model, the analysis unit uses a labeled audio dataset, applies CTC loss or cross-entropy loss as the loss function, and optimizes the weight parameters by gradient descent. The analysis unit passes the speech recognition results to the subsequent natural language processing unit, which uses them as basic data for analysis and visualization of the discussion content. Unlike conventional manual transcription by humans, the analysis unit combines computer-specific technical methods such as automatic feature extraction in high-dimensional feature space, time-series pattern recognition by deep learning models, and real-time data flow control, thereby achieving significant improvements in speech recognition accuracy and processing speed. The analysis unit can also structure the speech recognition results in JSON or CSV format and link them to the history management unit or display control unit. Examples of AI model input/output include input as “16 kHz, 5 seconds of PCM audio data,” and output as text such as “Plan B is easy to implement.” In subsequent processing, the text data is used for semantic analysis and comparison item extraction in the natural language processing unit. Specific application fields include online meetings in companies, discussion classes in educational settings, remote medical conferences, policy-making workshops, and AI-based automatic minutes generation services.

The analysis unit can analyze text-converted conversation content using natural language processing technology. The natural language processing technology may include, for example, morphological analysis, grammatical analysis, and semantic analysis. The natural language processing technology receives text data as input and outputs analysis results. For example, the natural language processing technology can analyze text data to understand the structure and meaning of sentences. Additionally, the natural language processing technology can perform keyword extraction and topic modeling. For example, the natural language processing technology extracts important keywords from text data and performs topic modeling. Furthermore, the natural language processing technology can perform sentiment analysis and intent recognition. For example, the natural language processing technology analyzes emotions from text data and recognizes the speaker's intent. Thus, by using natural language processing technology, the accuracy of conversation content analysis is improved. Some or all of the above-described processing in the analysis unit may be performed using AI, or may be performed without using AI. For example, the analysis unit can input text data into a generative AI and have the generative AI generate analysis results. Specifically, the analysis unit receives text data output from the speech recognition unit (e.g., “Plan A has low cost. Plan B is easy to implement.”) as input. The analysis unit first applies a morphological analysis engine (e.g., word segmentation, part-of-speech tagging) to extract words and part-of-speech information from the sentence. Next, the analysis unit performs syntactic analysis (dependency parsing) to clarify the structural relationships in the sentence. For semantic analysis, the analysis unit uses pre-trained large-scale language models (e.g., BERT, RoBERTa) to generate context vectors and represent the semantic features of utterances in high-dimensional vector space. For topic extraction, the analysis unit applies algorithms such as LDA (Latent Dirichlet Allocation) or k-means clustering to classify conversation content into multiple topics. For comparison expression detection, the analysis unit uses rule-based pattern matching or classifier models based on Transformer-type models (e.g., BERT, RoBERTa) to automatically extract comparison structures such as “Plan A is ~, Plan B is ~.” For sentiment analysis, the analysis unit applies pre-trained sentiment classification models (e.g., LSTM, Transformer) to output emotion labels such as positive, negative, neutral, and scores (e.g., 0.85, −0.12) for each utterance. For intent recognition, the analysis unit applies intent recognition models that classify the purpose of the utterance (e.g., proposal, objection, question). The analysis unit outputs these analysis results as structured data (e.g., topic labels, comparison items, emotion scores, intent labels in JSON format) and links them to subsequent comparison extraction units and visualization units. Unlike conventional manual document reading or minutes creation by humans, the analysis unit combines computer-specific technical methods such as semantic feature extraction in high-dimensional vector space, context understanding by neural networks, hybrid comparison item extraction using rule-based and machine learning approaches, and real-time data flow control, thereby achieving significant improvements in the accuracy and speed of conversation content analysis. Examples of AI model input/output include input as “Plan A has low cost. Plan B is easy to implement,” and output as comparison table data such as “Plan A: low cost” and “Plan B: easy implementation,” or structured data such as “Topic A: number of utterances 5, emotion score 0.8.” In subsequent processing, the analysis results are rendered in tabular or graph format by the display unit. Specific application fields include online meetings in companies, discussion classes in educational settings, remote medical conferences, policy-making workshops, and AI-based automatic minutes generation services.

The display unit can extract different patterns of content and display them in a tabular format. For example, the display unit extracts the content of Pattern A and Pattern B and displays it in a tabular format. The display unit can create tables using HTML or CSS, for example. The display unit receives analysis results as input and outputs tables. For example, the display unit compares the content of Pattern A and Pattern B and displays them in a tabular format. Additionally, the display unit can customize the layout and design of the table. For example, the display unit can change the color and font of the table to provide visually easy-to-read displays. Furthermore, the display unit can update the content of the table in real time. For example, the display unit automatically updates the content of the table according to the progress of the conversation. By displaying the content of Pattern A and Pattern B in a tabular format, comparison becomes easier. Some or all of the above-described processing in the display unit may be performed using AI, or may be performed without using AI. For example, the display unit can input analysis results into a generative AI and have the generative AI generate tables. Specifically, the display unit receives comparison table data (e.g., item labels and value pairs such as “Plan A: low cost,” “Plan B: easy implementation” in JSON format) from the analysis unit as input. The display unit uses web technologies such as HTML5, CSS3, and JavaScript to render two-dimensional array tables in real time. The display unit dynamically generates table columns (e.g., item name, Pattern A, Pattern B) and rows (e.g., cost, ease of implementation, scalability, etc.) and optimizes the layout for easy visual comparison by users. The display unit provides customization functions such as color coding (e.g., Plan A in blue, Plan B in red), font size, and cell highlighting (e.g., bold for important items, background color change). The display unit automatically updates the content of the table and instantly reflects it on the user interface when new comparison items or values are added from the analysis unit according to the progress of the conversation. The display unit also supports user operations (e.g., column sorting, filtering, hiding items) to provide an interactive comparison experience. The display unit can use AI models (e.g., generative large language models) to automatically generate tables and optimize layouts from analysis results. Examples of AI model input/output include input as comparison table data such as “Plan A: low cost,” “Plan B: easy implementation,” and output as HTML table structure or table data in JSON format. In subsequent processing, the table data is visualized by the visualization unit or saved by the history management unit. Unlike conventional manual table creation by humans, the display unit combines computer-specific technical methods such as real-time data linkage, dynamic layout optimization, immediate response to user operations, and AI-based automatic generation, thereby achieving significant improvements in the efficiency and accuracy of comparison table creation and display. Specific application fields include decision-making support in companies, comparative learning in educational settings, comparison of treatment methods in medical settings, policy-making workshops, and AI-based automatic minutes generation services.

The visualization unit can create graphs for each discussion topic and visually indicate how much each topic has been discussed. For example, the visualization unit creates graphs for each discussion topic and visually indicates how much each topic has been discussed. The visualization unit can use bar graphs, pie charts, line graphs, etc. The visualization unit receives analysis results as input and outputs graphs. For example, the visualization unit displays the progress of the discussion for each topic in a graph. Additionally, the visualization unit can customize the design and layout of the graph. For example, the visualization unit can change the color and font of the graph to provide visually easy-to-read displays. Furthermore, the visualization unit can update the content of the graph in real time. For example, the visualization unit automatically updates the content of the graph according to the progress of the conversation. By creating graphs for each discussion topic, the balance of the discussion can be checked. Some or all of the above-described processing in the visualization unit may be performed using AI, or may be performed without using AI. For example, the visualization unit can input analysis results into a generative AI and have the generative AI generate graphs. Specifically, the visualization unit receives metadata such as the number of utterances per topic, utterance time, emotion scores, etc., from the analysis unit as input. The visualization unit can apply multiple visualization methods such as bar graphs (number of utterances per topic), pie charts (distribution of discussion time), line graphs (transition of utterance count over time), and network diagrams (relationships between speakers). The visualization unit customizes color schemes, fonts, label display, axis scaling, etc., so that users can intuitively grasp the balance and progress of the discussion. The visualization unit automatically updates the content of the graph and instantly reflects it on the user interface when new topics or utterance data are added from the analysis unit according to the progress of the conversation. The visualization unit can use AI models (e.g., generative large language models or graph auto-generation AI) to automatically select and generate the optimal graph format and layout from analysis results. Examples of AI model input/output include input as structured data such as “Topic A: number of utterances 5, Topic B: number of utterances 10,” and output as graph images in SVG or PNG format, or drawing data for HTML5 Canvas. In subsequent processing, the graph data is rendered by the display unit or saved by the history management unit. Unlike conventional manual graph creation by humans, the visualization unit combines computer-specific technical methods such as real-time data linkage, dynamic layout optimization, and AI-based automatic generation, thereby achieving significant improvements in the efficiency and accuracy of discussion visualization. Specific application fields include meeting analysis in companies, visualization of discussions in educational settings, management of discussion progress in medical conferences, policy-making workshops, and AI-based automatic minutes generation services.

The storage unit can store the history of the discussion and provide information for resuming the discussion later. For example, the storage unit saves the history of the discussion in a database and provides information for resuming the discussion later. The storage unit receives analysis results as input and outputs stored data. For example, the storage unit saves the history of the discussion in chronological order, allowing the discussion to continue from that point upon resumption. Additionally, the storage unit can customize the format and retention period of the stored data. For example, the storage unit saves data in text format or image format and sets the retention period. Furthermore, the storage unit can update the stored data in real time. For example, the storage unit automatically updates the stored data according to the progress of the conversation. By storing the history of the discussion, interrupted discussions can be resumed later. Some or all of the above-described processing in the storage unit may be performed using AI, or may be performed without using AI. For example, the storage unit can input analysis results into a generative AI and have the generative AI generate stored data. Specifically, the storage unit saves utterance content, speaker, timestamp, analysis results, visualization data, etc., received from the analysis unit or visualization unit in a database (e.g., NoSQL type, time-series DB) in chronological order. The storage unit can flexibly customize the storage format, selecting from JSON, CSV, images (SVG, PNG), audio files, etc., according to user or system requirements. The storage unit sets the retention period (e.g., one week, one month, one year) and storage policy (e.g., long-term storage for important data, short-term storage for regular data) to balance storage efficiency and data integrity. The storage unit automatically updates the stored data and maintains the latest discussion history when new utterances or analysis results are added from the analysis unit according to the progress of the conversation. The storage unit can use AI models (e.g., generative large language models) to automatically generate stored data, summaries, and metadata from analysis results. Examples of AI model input/output include input as structured data such as “utterance content, speaker, timestamp, analysis results,” and output as history data in JSON format or summary text. In subsequent processing, the stored data is read by the analysis unit or display unit upon resumption and used for continuing or redisplaying the discussion. Unlike conventional manual minutes creation or history management by humans, the storage unit combines computer-specific technical methods such as real-time data linkage, dynamic storage and updating, and AI-based automatic summarization and metadata assignment, thereby achieving significant improvements in the efficiency and accuracy of discussion history storage and resumption support. Specific application fields include meeting record management in companies, storage of discussion history in educational settings, recording of discussions in medical conferences, policy-making workshops, and AI-based automatic minutes generation services.

The analysis unit can estimate emotions in the conversation and adjust the accuracy of analysis based on the estimated emotions. For example, the analysis unit estimates emotions in the conversation and increases the accuracy of analysis when emotions are heightened. The analysis unit can use emotion estimation algorithms to estimate emotions in the conversation. The emotion estimation algorithm may use, for example, facial expression recognition, audio analysis, or text analysis. The emotion estimation algorithm receives conversation audio data or text data as input and outputs emotion scores. For example, when emotions are heightened, the analysis unit performs more detailed analysis to increase the accuracy of analysis. When emotions are calm, the analysis unit maintains normal accuracy. Furthermore, when emotions are unstable, the analysis unit can dynamically adjust the accuracy of analysis. For example, when emotions are unstable, the analysis unit dynamically adjusts the accuracy of analysis to provide optimal analysis results. By adjusting the accuracy of analysis based on emotions in the conversation, the accuracy of analysis results is improved. Emotion estimation may be implemented using, for example, an emotion engine or generative AI. The generative AI may be a text generation AI (e.g., LLM) or a multimodal generative AI, but is not limited to these examples. Some or all of the above-described processing in the analysis unit may be performed using AI, or may be performed without using AI. For example, the analysis unit can input emotion data into a generative AI and have the generative AI perform accuracy adjustment of analysis. Specifically, the analysis unit receives multiple input data for emotion estimation processing. The analysis unit simultaneously receives 16 kHz, 16 bit, monaural PCM format audio data output from the speech recognition unit, facial image data obtained from a webcam (e.g., 128×128 pixel RGB image), and text-converted utterance data (e.g., “I absolutely want this proposal to pass!”) as input. The analysis unit performs spectrogram conversion and MFCC extraction on audio data, face region detection and facial feature point extraction (e.g., 68 landmarks for eyes, mouth, eyebrows) on facial image data, and context vectorization using pre-trained large language models on text data. The analysis unit inputs these features into a multimodal emotion estimation model combining multilayer perceptrons, convolutional neural networks, recurrent neural networks, Transformer-type models, etc. The model outputs “emotion scores” (e.g., positive 0.85, negative 0.10, neutral 0.05) and “emotion labels” (e.g., anger, joy, sadness). For example, when the input is “high-pitched speech with anger+grim facial expression image+text ‘Why does this happen?’,” the output is “anger: 0.92.” Another example is “calm voice+smiling facial expression+text ‘Let's proceed with this proposal’,” with output “joy: 0.80.” When the emotion score is heightened (e.g., anger score 0.8 or higher), the analysis unit automatically switches the analysis parameters of the natural language processing unit (e.g., number of clusters for topic extraction, threshold for comparison expression detection, window width for emotion analysis) to high-precision mode and performs more detailed analysis (e.g., tracking emotion changes per utterance, analyzing emotional tendencies per speaker). When emotions are calm, normal analysis parameters are applied, and when emotions are unstable, the analysis accuracy is dynamically adjusted (e.g., shortening the analysis window width to prioritize real-time performance). In training the emotion estimation model, the analysis unit uses multimodal datasets of audio, image, and text (e.g., EmotionX, IEMOCAP), applies cross-entropy loss or multitask loss functions, and optimizes weights on GPU clusters. The analysis unit can link the estimated emotion scores to the history management unit or visualization unit to visualize the emotional excitement or calmness of the discussion over time. Unlike conventional subjective emotion judgment or simple keyword-based emotion estimation by humans, the analysis unit combines computer-specific technical methods such as multimodal feature extraction in high-dimensional feature space, complex emotion estimation by deep learning models, and real-time analysis parameter control, thereby achieving optimization of analysis accuracy according to emotions and improvement of reliability of analysis results. Specific application fields include detection and response to emotional discussions in online meetings in companies, monitoring of students' emotional changes in educational settings, analysis of emotional interactions between patients and doctors in remote medical conferences, emotion analysis in consensus-building processes in policy-making workshops, and emotion tagging functions in AI-based automatic minutes generation services.

The analysis unit can understand the context of the conversation and automatically highlight important keywords. For example, the analysis unit understands the context of the conversation and highlights important keywords in bold. The analysis unit can analyze the context of the conversation using natural language processing technology. The natural language processing technology may use, for example, morphological analysis, grammatical analysis, and semantic analysis. The natural language processing technology receives text data as input and outputs analysis results for understanding context. For example, the analysis unit understands the context of the conversation and highlights important keywords by color coding. The analysis unit can also highlight important keywords with underlining. Furthermore, the analysis unit can highlight important keywords in real time. For example, the analysis unit automatically highlights important keywords according to the progress of the conversation. By highlighting important keywords, the important points of the conversation become clear. Some or all of the above-described processing in the analysis unit may be performed using AI, or may be performed without using AI. For example, the analysis unit can input text data into a generative AI and have the generative AI perform keyword highlighting. Specifically, the analysis unit receives text data output from the speech recognition unit (e.g., “Plan A has low cost. Plan B is easy to implement.”) as input. The analysis unit first uses a morphological analysis engine to perform word segmentation and part-of-speech tagging, extracting part-of-speech information (e.g., noun, verb, adjective) for each word. Next, the analysis unit performs syntactic analysis (dependency parsing) to clarify structural relationships such as subject, predicate, and object in the sentence. For semantic analysis, the analysis unit uses pre-trained large language models (e.g., BERT, RoBERTa) to generate context vectors and represent semantic features of each word or phrase in high-dimensional space. For important keyword extraction, the analysis unit applies TF-IDF score calculation, attention weight analysis, rule-based pattern matching, or important word classifier using Transformer-type models. For example, for input such as “Plan A has low cost. Plan B is easy to implement,” the analysis unit extracts “Plan A,” “cost,” “Plan B,” “easy implementation,” etc., as important keywords. The analysis unit generates structured data with highlighting attributes (e.g., bold, color coding, underline, background color change) for the extracted keywords (e.g., HTML-tagged text, JSON format highlighting range information). The analysis unit updates the highlighting range in real time and instantly reflects it in the display unit when new keywords appear according to the progress of the conversation. The analysis unit allows customization of highlighting methods (e.g., color, font, animation) according to user settings and use cases. Examples of AI model input/output include input as “Plan A has low cost. Plan B is easy to implement,” and output as highlighted text such as “Plan A,” “cost,” “Plan B,” “easy implementation.” In subsequent processing, the highlighted data is rendered by the display unit and used as annotations in graphs or charts by the visualization unit. Unlike conventional subjective keyword selection or simple frequency-based highlighting by humans, the analysis unit combines computer-specific technical methods such as semantic feature extraction in high-dimensional vector space, attention weight analysis, and real-time highlighting range control, thereby achieving clarification of important points in the conversation and improvement of user experience. Specific application fields include visualization of important discussion points in decision-making meetings in companies, emphasis of key points in educational settings, highlighting of diagnostic grounds in medical conferences, organization of discussion points in policy-making workshops, and summary highlighting functions in AI-based automatic minutes generation services.

The analysis unit can update analysis results in real time according to the progress of the conversation. For example, the analysis unit updates analysis results in real time according to the progress of the conversation and reflects the latest information. The analysis unit can analyze the progress of the conversation using natural language processing technology. The natural language processing technology may use, for example, morphological analysis, grammatical analysis, and semantic analysis. The natural language processing technology receives text data as input and outputs analysis results for understanding progress. For example, the analysis unit updates analysis results in real time according to the progress of the conversation and highlights important points. The analysis unit can also update analysis results in real time according to the progress of the conversation and indicate the direction of the discussion. Furthermore, the analysis unit can display analysis results in real time. For example, the analysis unit automatically updates analysis results according to the progress of the conversation and sends them to the display unit. By updating analysis results in real time, the latest information is reflected. Some or all of the above-described processing in the analysis unit may be performed using AI, or may be performed without using AI. For example, the analysis unit can input text data into a generative AI and have the generative AI update analysis results. Specifically, the analysis unit receives a stream of text data (e.g., JSON format utterance data updated for each utterance) sequentially from the speech recognition unit or history management unit as input. The analysis unit links multiple natural language processing modules such as morphological analysis, syntactic analysis, semantic analysis, topic extraction, comparison expression detection, sentiment analysis in a pipeline configuration, and sequentially generates analysis results for each utterance unit or time window. The analysis unit manages analysis results (e.g., topic labels, comparison items, emotion scores, important keywords) in chronological order and aggregates the state of the ongoing discussion (e.g., current topic, number of utterances per speaker, trends in emotional changes) in real time. When a new topic appears according to the progress of the conversation, the analysis unit immediately updates topic labels and analysis priorities and generates data with flags for highlighting important points (e.g., new discussion points, signs of consensus formation, occurrence of conflicts). The analysis unit automatically determines the direction of the discussion (e.g., ratio of agreement/disagreement, trend of topic diffusion/convergence) and notifies the display unit or visualization unit. Examples of AI model input/output include input as “utterance stream (e.g., text for each utterance),” and output as structured data such as “Topic A: number of utterances 5, emotion score 0.8, important point: cost reduction.” In subsequent processing, the analysis results are rendered in tabular or graph format by the display unit and saved in chronological order by the history management unit. Unlike conventional manual minutes creation or manual progress management by humans, the analysis unit combines computer-specific technical methods such as real-time data stream analysis, state estimation in high-dimensional feature space, AI-based automatic flag assignment, and pipeline-type data flow control, thereby achieving immediate reflection of the latest information and efficiency in discussion progress management. Specific application fields include progress management in online meetings in companies, visualization of discussion progress in educational settings, tracking of discussion progress in medical conferences, management of discussion points in policy-making workshops, and real-time summary functions in AI-based automatic minutes generation services.

The analysis unit can estimate emotions in the conversation and adjust the display method of analysis results based on the estimated emotions. For example, the analysis unit estimates emotions in the conversation and highlights analysis results when emotions are heightened. The analysis unit can use emotion estimation algorithms to estimate emotions in the conversation. The emotion estimation algorithm may use, for example, facial expression recognition, audio analysis, or text analysis. The emotion estimation algorithm receives conversation audio data or text data as input and outputs emotion scores. For example, when emotions are heightened, the analysis unit sends instructions to the display unit to highlight analysis results. When emotions are calm, the analysis unit displays analysis results normally. Furthermore, when emotions are unstable, the analysis unit can dynamically adjust the display method of analysis results to provide optimal display. By adjusting the display method based on emotions, more appropriate display is possible. Emotion estimation may be implemented using, for example, an emotion engine or generative AI. The generative AI may be a text generation AI (e.g., LLM) or a multimodal generative AI, but is not limited to these examples. Some or all of the above-described processing in the analysis unit may be performed using AI, or may be performed without using AI. For example, the analysis unit can input emotion data into a generative AI and have the generative AI adjust the display method. Specifically, the analysis unit simultaneously receives 16 kHz, 16 bit, monaural PCM format audio data output from the speech recognition unit, facial image data obtained from a webcam (e.g., 128×128 pixel RGB image), and text-converted utterance data (e.g., “I absolutely want this proposal to pass!”) as input. The analysis unit performs spectrogram conversion and MFCC extraction on audio data, face region detection and facial feature point extraction (e.g., 68 landmarks for eyes, mouth, eyebrows) on facial image data, and context vectorization using pre-trained large language models on text data. The analysis unit inputs these features into a multimodal emotion estimation model combining multilayer perceptrons, convolutional neural networks, recurrent neural networks, Transformer-type models, etc. The model outputs “emotion scores” (e.g., positive 0.85, negative 0.10, neutral 0.05) and “emotion labels” (e.g., anger, joy, sadness). Examples of input include “high-pitched speech with anger+grim facial expression image+text ‘Why does this happen?’” and “calm voice+smiling facial expression+text ‘Let's proceed with this proposal’,” with output examples “anger: 0.92” and “joy: 0.80.” When the emotion score is heightened, the analysis unit instructs the display unit to highlight analysis results (e.g., change background color, enlarge font size, add animation). When emotions are calm, normal display is applied, and when emotions are unstable, the display method (e.g., color tone, degree of emphasis, display order) is dynamically adjusted. These controls are transmitted from the analysis unit to the display unit as structured data (e.g., JSON format “highlight display: true,” “emphasis degree: 0.8”). Examples of AI model input/output include input as multimodal data of audio, image, and text, and output as emotion score, emotion label, and display highlight instructions. In subsequent processing, the display unit immediately changes the display method of analysis results based on the received instructions. Unlike conventional subjective emotion judgment or simple keyword-based highlighting by humans, the analysis unit combines computer-specific technical methods such as multimodal feature extraction in high-dimensional feature space, complex emotion estimation by deep learning models, and real-time display control, thereby achieving optimization of analysis result display according to emotions and improvement of user experience. Specific application fields include visualization of emotional discussions in online meetings in companies, emphasis of key points according to students' emotional changes in educational settings, analysis of emotional interactions between patients and doctors in remote medical conferences, emotion analysis in consensus-building processes in policy-making workshops, and emotion tagging functions in AI-based automatic minutes generation services.

The analysis unit can refer to background information of the conversation and automatically add related information. For example, the analysis unit refers to background information of the conversation and automatically adds related information for display. The analysis unit can analyze background information of the conversation using natural language processing technology. The natural language processing technology may use, for example, morphological analysis, grammatical analysis, and semantic analysis. The natural language processing technology receives text data as input and outputs analysis results for understanding background information. For example, the analysis unit refers to background information of the conversation and adds related information as links. The analysis unit can also add related information as annotations. Furthermore, the analysis unit can add related information in real time. For example, the analysis unit automatically adds related information according to the progress of the conversation and sends it to the display unit. By adding background information, understanding of the conversation is deepened. Some or all of the above-described processing in the analysis unit may be performed using AI, or may be performed without using AI. For example, the analysis unit can input text data into a generative AI and have the generative AI add related information. Specifically, the analysis unit receives text data (e.g., “Plan A has low cost. Plan B is easy to implement.”) received from the speech recognition unit or history management unit as input. The analysis unit first uses a morphological analysis engine to perform word segmentation and part-of-speech tagging, then performs syntactic analysis (dependency parsing) to clarify structural relationships such as subject, predicate, and object in the sentence. For semantic analysis, the analysis unit uses pre-trained large language models (e.g., BERT, RoBERTa) to generate context vectors and represent semantic features of utterances in high-dimensional vector space. For background information extraction, the analysis unit searches internal documents, past minutes, external knowledge bases (e.g., Wikipedia API, internal FAQ database) related to the conversation content, and applies similarity calculation (cosine similarity, vector distance) or rule-based keyword matching. For example, for the utterance “Plan A has low cost,” the analysis unit automatically extracts past discussions related to “Plan A” or case studies of “cost reduction” measures and generates related links or annotations (e.g., “Here is the case study of Plan A implementation in April 2023”). The analysis unit outputs the extracted related information as structured data (e.g., link list in JSON format, annotation text, relevance score) and sends it to the display unit. When new background information is needed according to the progress of the conversation, the analysis unit issues queries to external APIs or internal databases in real time and sequentially adds related information. Examples of AI model input/output include input as “Plan A has low cost. Plan B is easy to implement,” and output as link/annotation data such as “Plan A: link to past case study, cost reduction: annotation of related measures.” In subsequent processing, the display unit displays the received related information as hyperlinks or popup annotations on the user interface. Unlike conventional manual information search or annotation assignment by humans, the analysis unit combines computer-specific technical methods such as semantic feature extraction in high-dimensional vector space, automatic linkage with external knowledge bases, and real-time addition of related information, thereby achieving significant improvements in the depth of conversation understanding and information referability. Specific application fields include automatic presentation of supporting information in online meetings in companies, assignment of reference material links in educational settings, reference to past cases in medical conferences, automatic annotation of related laws in policy-making workshops, and automatic background information assignment functions in AI-based automatic minutes generation services.

The analysis unit can customize analysis results based on attribute information of participants in the conversation. For example, the analysis unit considers attribute information of participants in the conversation and customizes analysis results for display. The analysis unit can analyze attribute information of participants in the conversation using natural language processing technology. The natural language processing technology may use, for example, morphological analysis, grammatical analysis, and semantic analysis. The natural language processing technology receives text data as input and outputs analysis results for understanding attribute information. For example, the analysis unit considers attribute information of participants in the conversation and displays analysis results individually. The analysis unit can also display analysis results by group according to attribute information of participants in the conversation. Furthermore, the analysis unit can customize analysis results in real time based on attribute information. For example, the analysis unit automatically customizes analysis results according to the progress of the conversation and sends them to the display unit. By considering attribute information of participants, more appropriate analysis results can be obtained. Some or all of the above-described processing in the analysis unit may be performed using AI, or may be performed without using AI. For example, the analysis unit can input attribute information into a generative AI and have the generative AI customize analysis results. Specifically, the analysis unit obtains attribute information for each participant in the conversation (e.g., position, department, area of expertise, years of experience, purpose of participation) from a user profile database or pre-survey data and manages it in association with utterance data. The analysis unit receives utterance data (e.g., text with speaker ID) from the speech recognition unit or history management unit as input and generates structured data with attribute information assigned to each speaker (e.g., JSON format “utterance content, speaker ID, position, area of expertise”). The analysis unit applies natural language processing technology such as morphological analysis, syntactic analysis, and semantic analysis, and combines features of utterance content and participant attributes for analysis. For customization processing based on attribute information, the analysis unit executes display control by rule-based or AI models, such as “highlighting decision-making points for managers,” “detailed display of technical details for engineers,” or “adding annotations for basic terms for newcomers.” The analysis unit also supports group-based display of analysis results, aggregating and visualizing utterance tendencies and discussion balance by department or project unit. When new participants join or attribute information is updated according to the progress of the conversation, the analysis unit updates customization content of analysis results in real time and sends it to the display unit. Examples of AI model input/output include input as “utterance content+speaker attribute data,” and output as customized analysis results such as “text with highlights by position,” “data with annotations by area of expertise.” In subsequent processing, the display unit optimizes and displays the received customization results for each user. Unlike conventional uniform minutes display or manual consideration of attributes by humans, the analysis unit combines computer-specific technical methods such as automatic linkage of attribute information and utterance content, real-time customization control, and AI-based individual optimization, thereby achieving provision of analysis results optimized for each participant and improvement of discussion efficiency. Specific application fields include presentation of key points by role in multi-occupational meetings in companies, display of explanations by grade in educational settings, emphasis of information by professional occupation in medical conferences, organization of discussion points by stakeholder in policy-making workshops, and individual optimization functions in AI-based automatic minutes generation services.

The display unit can estimate emotions in the conversation and determine the priority of display content based on the estimated emotions. For example, the display unit estimates emotions in the conversation and prioritizes important information for display when emotions are heightened. The display unit can use emotion estimation algorithms to estimate emotions in the conversation. The emotion estimation algorithm may use, for example, facial expression recognition, audio analysis, or text analysis. The emotion estimation algorithm receives conversation audio data or text data as input and outputs emotion scores. For example, when emotions are heightened, the display unit adjusts the priority of display content to prioritize important information. When emotions are calm, the display unit displays content in the normal order. Furthermore, when emotions are unstable, the display unit can dynamically adjust the priority of information to provide optimal display. By determining the priority of display content based on emotions, important information is prioritized for display. Emotion estimation may be implemented using, for example, an emotion engine or generative AI. The generative AI may be a text generation AI (e.g., LLM) or a multimodal generative AI, but is not limited to these examples. Some or all of the above-described processing in the display unit may be performed using AI, or may be performed without using AI. For example, the display unit can input emotion data into a generative AI and have the generative AI determine the priority of display content. Specifically, the display unit receives multiple input data for emotion estimation processing. The display unit simultaneously receives 16 kHz, 16 bit, monaural PCM format audio data output from the speech recognition unit, facial image data obtained from a webcam (e.g., 128×128 pixel RGB image), and text-converted utterance data (e.g., “I absolutely want this proposal to pass!”) as input. The display unit performs spectrogram conversion and MFCC extraction on audio data, face region detection and facial feature point extraction (e.g., 68 landmarks for eyes, mouth, eyebrows) on facial image data, and context vectorization using pre-trained large language models on text data. The display unit inputs these features into a multimodal emotion estimation model combining multilayer perceptrons, convolutional neural networks, recurrent neural networks, Transformer-type models, etc. The model outputs “emotion scores” (e.g., positive 0.85, negative 0.10, neutral 0.05) and “emotion labels” (e.g., anger, joy, sadness). Examples of input include “high-pitched speech with anger+grim facial expression image+text ‘Why does this happen?’” and “calm voice+smiling facial expression+text ‘Let's proceed with this proposal’,” with output examples “anger: 0.92” and “joy: 0.80.” When the emotion score is heightened, the display unit assigns priority scores to analysis result data (e.g., key points by topic, important decision items, unresolved issues) received from the analysis unit or history management unit and automatically adjusts the display order to place important information at the top. When emotions are calm, the normal display order (e.g., chronological order, topic order) is maintained, and when emotions are unstable, the display unit dynamically recalculates display priority according to the range of emotion score fluctuations and emotional tendencies per utterance, enabling users to instantly grasp information that should be noted. Examples of AI model input/output include input as multimodal data of audio, image, text, and analysis result data, and output as analysis result data with emotion score, emotion label, and display priority. In subsequent processing, the display unit uses HTML5, CSS3, JavaScript, etc., to render tables or graphs with important information placed at the top in real time based on the received priority information. Unlike conventional subjective judgment of information priority or manual adjustment of display order by humans, the display unit combines computer-specific technical methods such as multimodal emotion estimation in high-dimensional feature space, complex emotion analysis by deep learning models, and real-time display priority control, thereby achieving optimization of information presentation according to emotions and improvement of user experience. Specific application fields include immediate emphasis of urgent topics in online meetings in companies, presentation of key points according to students' emotional changes in educational settings, priority display of important matters based on emotional interactions between patients and doctors in remote medical conferences, organization of discussion points based on emotion analysis in consensus-building processes in policy-making workshops, and emotion-priority summary functions in AI-based automatic minutes generation services.

The display unit can customize display content according to the user's visual preferences. For example, the display unit adjusts the color tone of display content according to the user's visual preferences. The display unit can change the color tone of display content based on user settings. For example, the display unit adjusts the color of display content based on the color scheme selected by the user. Additionally, the display unit can adjust the font size of display content according to the user's visual preferences. For example, the display unit changes the font size of display content based on the font size selected by the user. Furthermore, the display unit can adjust the layout of display content according to the user's visual preferences. For example, the display unit changes the arrangement of display content based on the layout selected by the user. By customizing according to visual preferences, user convenience is improved. Some or all of the above-described processing in the display unit may be performed using AI, or may be performed without using AI. For example, the display unit can input user setting data into a generative AI and have the generative AI customize display content. Specifically, the display unit obtains customization setting data for each user (e.g., color scheme, font size, layout preset, accessibility settings) from a user profile database and links it to the display control module. The display unit receives analysis result data (e.g., comparison tables, graphs, annotated text) from the analysis unit or history management unit as input and dynamically applies color tone (e.g., dark mode, high contrast, custom color palette), font size (e.g., 12 pt, 16 pt, 20 pt), and layout (e.g., single column, two columns, card type, grid type) using web technologies such as HTML5, CSS3, JavaScript according to user settings. When the user changes settings in real time, the display unit immediately redraws the display content to maintain consistency and comfort in the user experience. The display unit also supports accessibility requirements (e.g., color vision diversity, voice reading tags, magnified display) and provides optimized display for each user. The display unit can use AI models (e.g., generative large language models) to learn from the user's past operation history and preference patterns and provide optimal customization suggestions or automatic layout optimization. Examples of AI model input/output include input as “user setting data+analysis result data,” and output as customized HTML/CSS/JS code or optimized layout parameters. In subsequent processing, the customized display content is instantly reflected in the user interface of web browsers or AR glasses. Unlike conventional uniform screen display or manual customization work by humans, the display unit combines computer-specific technical methods such as user profile linkage, real-time display optimization, and AI-based automatic customization suggestions, thereby achieving optimized display experience and improved convenience for each user. Specific application fields include meeting systems for diverse occupations and age groups in companies, individualized learning support in educational settings, display for visually impaired users in medical settings, optimized display by participant attribute in policy-making workshops, and personalized display functions in AI-based automatic minutes generation services.

The display unit can update display content in real time and reflect the latest information. For example, the display unit updates display content in real time and reflects the latest information. The display unit can analyze the progress of the conversation using natural language processing technology and update display content. The natural language processing technology may use, for example, morphological analysis, grammatical analysis, and semantic analysis. The natural language processing technology receives text data as input and outputs analysis results for understanding progress. For example, the display unit updates display content in real time according to the progress of the conversation and reflects the latest information. The display unit can also highlight important points. For example, the display unit automatically highlights important points according to the progress of the conversation. Furthermore, the display unit can indicate the direction of the discussion. For example, the display unit displays the direction of the discussion according to the progress of the conversation. By updating display content in real time, the latest information is instantly reflected. Some or all of the above-described processing in the display unit may be performed using AI, or may be performed without using AI. For example, the display unit can input analysis results into a generative AI and have the generative AI update display content. Specifically, the display unit receives a stream of text data (e.g., JSON format utterance data updated for each utterance) or analysis result data (e.g., topic labels, comparison items, emotion scores, important keywords) sequentially from the analysis unit or history management unit as input. The display unit receives output from multiple natural language processing modules such as morphological analysis, syntactic analysis, semantic analysis, topic extraction, comparison expression detection, sentiment analysis in a pipeline manner and sequentially generates and updates display content for each utterance unit or time window. The display unit manages analysis results (e.g., Topic A: number of utterances 5, emotion score 0.8, important point: cost reduction) in chronological order, aggregates the state of the ongoing discussion (e.g., current topic, number of utterances per speaker, trends in emotional changes) in real time, and instantly reflects it in display content. When a new topic appears according to the progress of the conversation, the display unit immediately updates topic labels and analysis priorities, generates data with flags for highlighting important points (e.g., new discussion points, signs of consensus formation, occurrence of conflicts), and applies highlighting (e.g., bold, color coding, animation) using HTML5, CSS3, JavaScript. The display unit automatically determines the direction of the discussion (e.g., ratio of agreement/disagreement, trend of topic diffusion/convergence) and displays it as graphs or annotations on the user interface. Examples of AI model input/output include input as “utterance stream+analysis result data,” and output as “real-time updated HTML/CSS/JS code+data with highlight flags.” In subsequent processing, the updated display content is instantly reflected in the user interface of web browsers or AR glasses. Unlike conventional manual minutes creation or manual progress management by humans, the display unit combines computer-specific technical methods such as real-time data stream analysis, state estimation in high-dimensional feature space, AI-based automatic flag assignment, and pipeline-type data flow control, thereby achieving immediate reflection of the latest information and efficiency in discussion progress management. Specific application fields include progress management in online meetings in companies, visualization of discussion progress in educational settings, tracking of discussion progress in medical conferences, management of discussion points in policy-making workshops, and real-time summary functions in AI-based automatic minutes generation services.

The display unit can estimate emotions in the conversation and change the display format based on the estimated emotions. For example, the display unit estimates emotions in the conversation and changes the display format to highlight when emotions are heightened. The display unit can use emotion estimation algorithms to estimate emotions in the conversation. The emotion estimation algorithm may use, for example, facial expression recognition, audio analysis, or text analysis. The emotion estimation algorithm receives conversation audio data or text data as input and outputs emotion scores. For example, when emotions are heightened, the display unit adjusts the display format to highlight by changing the format of the display content. When emotions are calm, the display unit changes the display format to normal display. Furthermore, when emotions are unstable, the display unit can dynamically adjust the display format to provide optimal display. By changing the display format based on emotions, more appropriate display is possible. Emotion estimation may be implemented using, for example, an emotion engine or generative AI. The generative AI may be a text generation AI (e.g., LLM) or a multimodal generative AI, but is not limited to these examples. Some or all of the above-described processing in the display unit may be performed using AI, or may be performed without using AI. For example, the display unit can input emotion data into a generative AI and have the generative AI change the display format. Specifically, the display unit simultaneously receives 16 kHz, 16 bit, monaural PCM format audio data output from the speech recognition unit, facial image data obtained from a webcam (e.g., 128×128 pixel RGB image), and text-converted utterance data (e.g., “I absolutely want this proposal to pass!”) as input. The display unit performs spectrogram conversion and MFCC extraction on audio data, face region detection and facial feature point extraction (e.g., 68 landmarks for eyes, mouth, eyebrows) on facial image data, and context vectorization using pre-trained large language models on text data. The display unit inputs these features into a multimodal emotion estimation model combining multilayer perceptrons, convolutional neural networks, recurrent neural networks, Transformer-type models, etc. The model outputs “emotion scores” (e.g., positive 0.85, negative 0.10, neutral 0.05) and “emotion labels” (e.g., anger, joy, sadness). Examples of input include “high-pitched speech with anger+grim facial expression image+text ‘Why does this happen?’” and “calm voice+smiling facial expression+text ‘Let's proceed with this proposal’,” with output examples “anger: 0.92” and “joy: 0.80.” When the emotion score is heightened, the display unit automatically applies display formats (e.g., background color change, font size enlargement, animation, highlight frame) to analysis result data (e.g., key points by topic, important decision items, unresolved issues) received from the analysis unit or history management unit, enabling users to intuitively grasp information that should be noted. When emotions are calm, the normal display format (e.g., standard color, standard font size) is maintained, and when emotions are unstable, the display unit dynamically recalculates the display format according to the range of emotion score fluctuations and emotional tendencies per utterance, maintaining consistency and comfort in the user experience. Examples of AI model input/output include input as multimodal data of audio, image, text, and analysis result data, and output as analysis result data with emotion score, emotion label, and display format specification. In subsequent processing, the display unit renders highlight or normal display in real time using HTML5, CSS3, JavaScript based on the received display format information. Unlike conventional subjective emotion judgment or manual adjustment of display format by humans, the display unit combines computer-specific technical methods such as multimodal emotion estimation in high-dimensional feature space, complex emotion analysis by deep learning models, and real-time display format control, thereby achieving optimization of display format according to emotions and improvement of user experience. Specific application fields include highlight display of urgent topics in online meetings in companies, emphasis of key points according to students' emotional changes in educational settings, highlight display of important matters based on emotional interactions between patients and doctors in remote medical conferences, emphasis of discussion points based on emotion analysis in consensus-building processes in policy-making workshops, and emotion-highlighted summary functions in AI-based automatic minutes generation services.

The display unit can optimize display content for the user's device. For example, the display unit optimizes display content for the user's device and displays it for smartphones. The display unit can change the layout of display content according to the screen size of the user's device. For example, the display unit adjusts display content to fit the screen size of a smartphone. Additionally, the display unit can optimize display content for tablets. For example, the display unit adjusts display content to fit the screen size of a tablet. Furthermore, the display unit can optimize display content for desktops. For example, the display unit adjusts display content to fit the screen size of a desktop. By optimizing for the device, users can check information from various devices. Some or all of the above-described processing in the display unit may be performed using AI, or may be performed without using AI. For example, the display unit can input device information into a generative AI and have the generative AI optimize display content. Specifically, the display unit analyzes device information (e.g., screen resolution, pixel density, OS type, browser type, input method) obtained from the user's access terminal in real time and links it to the display control module. The display unit receives analysis result data (e.g., comparison tables, graphs, annotated text) from the analysis unit or history management unit as input and dynamically applies layout (e.g., responsive design, automatic adjustment of number of columns, card-type UI, optimization for touch operation), font size, button arrangement, and interaction method (e.g., swipe, pinch-in/out) using web technologies such as HTML5, CSS3, JavaScript according to device information. For smartphones, the display unit optimizes for vertical layout and touch operation; for tablets, it optimizes for two-column or grid layout; for desktops, it optimizes for multi-window display and mouse operation. When the user switches devices or changes screen size, the display unit immediately redraws the display content to maintain consistency and comfort in the user experience. The display unit can use AI models (e.g., generative large language models) to learn from past device usage history and user operation patterns and provide optimal layout suggestions or automatic UI optimization. Examples of AI model input/output include input as “device information+analysis result data,” and output as optimized HTML/CSS/JS code or layout parameters. In subsequent processing, the optimized display content is instantly reflected in the user interface of web browsers or AR glasses. Unlike conventional uniform screen display or manual device optimization work by humans, the display unit combines computer-specific technical methods such as device information linkage, real-time display optimization, and AI-based automatic layout suggestions, thereby achieving optimized display experience and improved convenience for each user and device. Specific application fields include meeting systems in BYOD environments in companies, multi-device learning support in educational settings, information sharing between tablets, smartphones, and desktops in medical settings, optimized display for field terminals in policy-making workshops, and cross-device support functions in AI-based automatic minutes generation services.

The display unit can display content in cooperation with other applications. For example, the display unit cooperates with other applications to display content in a schedule management app. The display unit can share data with other applications using APIs. For example, the display unit sends display content to a schedule management app and reflects it in the schedule. Additionally, the display unit can cooperate with a project management app. For example, the display unit sends display content to a project management app and reflects it in the progress of the project. Furthermore, the display unit can cooperate with a messaging app. For example, the display unit sends display content to a messaging app and displays it as a message. By cooperating with other applications, information sharing becomes easier. Some or all of the above-described processing in the display unit may be performed using AI, or may be performed without using AI. For example, the display unit can input API information into a generative AI and have the generative AI perform cooperation with other applications. Specifically, the display unit manages API information for external application cooperation (e.g., REST API endpoints, OAuth authentication tokens, data schema definitions) and receives analysis result data (e.g., meeting summary, minutes, task list, schedule information) from the analysis unit or history management unit as input. The display unit automatically converts data formats (e.g., JSON, XML, CSV) according to API specifications and sends data according to the requirements of external applications. For schedule management apps, the display unit registers meeting schedules and tasks as calendar events; for project management apps, it reflects discussion progress and task status on the project board; for messaging apps, it sends key points and alerts as chat messages. The display unit monitors the success of API cooperation and data synchronization status, and automatically performs retransmission or user notification in case of errors. The display unit can use AI models (e.g., generative large language models) to automate data mapping and cooperation flow optimization for each external application, and provide cooperation suggestions or automatic settings according to the user's workflow. Examples of AI model input/output include input as “API information+analysis result data,” and output as “data structure for external applications” or “cooperation flow control parameters.” In subsequent processing, the cooperated data is instantly reflected in external applications, enabling users to seamlessly utilize information across multiple business tools. Unlike conventional manual data entry or application cooperation work by humans, the display unit combines computer-specific technical methods such as automatic API cooperation, data format conversion, and AI-based cooperation flow optimization, thereby achieving efficiency in information sharing and automation of business processes. Specific application fields include groupware cooperation in companies, cooperation with learning management systems in educational settings, cooperation between electronic medical records and schedulers in medical settings, cooperation with project management tools in policy-making workshops, and external application cooperation functions in AI-based automatic minutes generation services.

The visualization unit can estimate emotions during a conversation and adjust the visualization method based on the estimated emotions. For example, the visualization unit estimates emotions during a conversation and, if the emotions are heightened, changes the visualization method to highlight. The visualization unit may use an emotion estimation algorithm to estimate emotions during a conversation. The emotion estimation algorithm may utilize, for example, facial expression recognition, voice analysis, and text analysis. The emotion estimation algorithm takes voice data and text data from the conversation as input and outputs an emotion score. For example, the visualization unit, when emotions are heightened, adjusts the design of graphs and charts (such as emphasizing red background colors, enlarging font size, adding animations, and displaying highlight frames) to change the visualization method to highlight. When emotions are calm, the visualization unit changes the visualization method to normal display. Furthermore, when emotions are unstable, the visualization unit can adjust the visualization method dynamically to provide optimal display. For example, when emotions are unstable, the visualization unit dynamically adjusts the visualization method to provide the best possible display. By adjusting the visualization method based on emotions, more appropriate visualization becomes possible. Emotion estimation may be implemented using an emotion engine or generative AI, such as text generation AI (e.g., LLM) or multimodal generative AI, but is not limited to these examples. Some or all of the above-described processing in the visualization unit may be performed using AI or without using AI. For example, the visualization unit may input emotion data to generative AI and have the generative AI execute the adjustment of the visualization method. Specifically, the visualization unit simultaneously receives multiple inputs such as 16 kHz, 16 bit, monaural PCM format voice data received from the speech recognition unit or analysis unit, 128×128 pixel RGB facial image data, and text-converted utterance data (e.g., “I absolutely want this proposal to pass!”). The visualization unit performs spectrogram conversion and MFCC extraction on voice data, facial region detection and facial feature point extraction (e.g., 68 landmarks for eyes, mouth, and eyebrows) on facial image data, and context vectorization using a pre-trained large language model on text data. These feature quantities are input to a multimodal emotion estimation model that combines multilayer perceptrons, convolutional neural networks, recurrent neural networks, Transformer models, etc. The visualization unit obtains model outputs such as “emotion scores” (e.g., positive 0.85, negative 0.10, neutral 0.05) and “emotion labels” (e.g., anger, joy, sadness, etc.). Input examples include “high-pitched speech with anger+grim facial image+text ‘Why is this happening?’” or “calm voice+smiling facial image+‘Let's proceed with this proposal,’” and output examples are “anger: 0.92” or “joy: 0.80.” When the emotion score is heightened, the visualization unit automatically applies design changes to graphs and charts (e.g., emphasizing red background, enlarging font size, adding animation, displaying highlight frames) so that users can intuitively grasp information that requires attention. When emotions are calm, the visualization unit maintains the standard visualization format (e.g., standard colors, standard font size), and when emotions are unstable, it dynamically recalculates the visualization method according to the fluctuation range of emotion scores and the emotional tendency of each utterance, maintaining consistency and comfort in the user experience. For AI model input/output examples, the input is “multimodal data of voice, image, text+analysis result data,” and the output is “emotion score, emotion label, graph data with visualization method specification.” In subsequent processing, the visualization unit draws highlight or normal display in real time using HTML5, CSS3, JavaScript, etc., based on the received visualization method information. Unlike conventional subjective emotion judgment by humans or manual adjustment of visualization methods, the visualization unit combines computer-specific technical methods such as multimodal emotion estimation in high-dimensional feature space, complex emotion analysis using deep learning models, and real-time visualization method control, thereby achieving technical effects such as optimization of visualization methods according to emotions and improvement of user experience. Specific application fields include visualization of emotional discussions in corporate online meetings, emphasis of key points according to students' emotional changes in educational settings, highlighting important matters based on emotional exchanges between patients and doctors in remote medical conferences, emphasis of discussion points based on emotion analysis in policy-making workshops, and emotion-highlighted graph generation functions in AI-based automatic minutes generation services.

The visualization unit can visualize the progress of a discussion in real time and highlight important points. For example, the visualization unit visualizes the progress of a discussion in real time and highlights important points in bold. The visualization unit may use natural language processing technology to analyze the progress of a discussion. Natural language processing technology may utilize, for example, morphological analysis, grammatical analysis, and semantic analysis. Natural language processing technology takes text data as input and outputs analysis results for understanding the progress. For example, the visualization unit visualizes the progress of a discussion in real time and highlights important points by color coding. The visualization unit can also highlight important points with underlines. Furthermore, the visualization unit can highlight important points in real time. For example, the visualization unit automatically highlights important points according to the progress of the conversation. By visualizing in real time, important points in the discussion become clear. Some or all of the above-described processing in the visualization unit may be performed using AI or without using AI. For example, the visualization unit may input text data to generative AI and have the generative AI execute the highlighting of important points. Specifically, the visualization unit receives as input a stream of text data (e.g., JSON format utterance data updated per utterance) and analysis result data (e.g., topic labels, comparison items, emotion scores, important keywords, etc.) sequentially from the analysis unit or history management unit. The visualization unit receives outputs from multiple natural language processing modules such as morphological analysis, syntactic analysis, semantic analysis, topic extraction, comparison expression detection, and emotion analysis in a pipeline manner, and generates and updates visualization content for each utterance unit or time window. The visualization unit manages analysis results (e.g., topic A: 5 utterances, emotion score 0.8, important point: cost reduction, etc.) in chronological order, aggregates the state of the ongoing discussion (e.g., current topic, number of utterances per speaker, trends in emotional changes, etc.) in real time, and immediately reflects them in the visualization content. The visualization unit generates important points (e.g., new issues, signs of consensus formation, occurrence of conflicts, etc.) as data with highlight flags and applies highlighting (e.g., bold, color coding, underline, animation, etc.) using HTML5, CSS3, JavaScript, etc. The visualization unit allows customization of highlighting methods (e.g., color, font, animation, etc.) according to user settings and use cases. For AI model input/output examples, the input is “utterance stream+analysis result data,” and the output is “real-time updated HTML/CSS/JS code+data with highlight flags.” In subsequent processing, the updated visualization content is immediately reflected in user interfaces such as web browsers or AR glasses. Unlike conventional manual minute creation or manual progress management by humans, the visualization unit combines computer-specific technical methods such as real-time data stream analysis, state estimation in high-dimensional feature space, automatic flagging by AI, and pipeline-type data flow control, thereby achieving technical effects such as immediate reflection of the latest information, efficient management of discussion progress, and clarification of important points. Specific application fields include progress management in corporate online meetings, visualization of discussion progress in educational settings, tracking of discussion progress in medical conferences, management of issue progress in policy-making workshops, and real-time summarization functions in AI-based automatic minutes generation services.

The visualization unit can apply different visualization methods for each topic of a discussion. For example, the visualization unit applies different visualization methods for each topic of a discussion and displays them as graphs. The visualization unit may use natural language processing technology to analyze the topics of a discussion. Natural language processing technology may utilize, for example, morphological analysis, grammatical analysis, and semantic analysis. Natural language processing technology takes text data as input and outputs analysis results for understanding topics. For example, the visualization unit applies different visualization methods for each topic of a discussion and displays them in a tabular format. The visualization unit can also display different visualization methods for each topic as images. Furthermore, the visualization unit can apply different visualization methods in real time. For example, the visualization unit automatically applies different visualization methods according to the progress of the conversation and sends them to the display unit. By applying different visualization methods for each topic, the content of the discussion becomes easier to understand. Some or all of the above-described processing in the visualization unit may be performed using AI or without using AI. For example, the visualization unit may input text data to generative AI and have the generative AI execute the application of visualization methods. Specifically, the visualization unit receives as input topic-classified text data and structured data (e.g., topic A: cost, topic B: ease of introduction, etc.) received from the analysis unit. The visualization unit applies natural language processing techniques such as morphological analysis, syntactic analysis, semantic analysis, and topic extraction (e.g., LDA, k-means clustering, etc.) to classify each utterance and discussion content into multiple topics. The visualization unit automatically selects the optimal visualization method for each topic (e.g., bar graphs for cost-related topics, tabular format for ease of introduction, line graphs for emotional changes, network diagrams for relationships, flowcharts for processes, etc.) and renders them in real time using HTML5, CSS3, JavaScript, WebGL, etc. The visualization unit dynamically applies color coding, fonts, and animation effects (e.g., fade-in for new topics, bounce display for important topics, etc.) for each topic, enabling users to intuitively grasp the overall picture of the discussion and the differences in issues. The visualization unit may use AI models (e.g., generative large language models or automatic graph generation AI) to automatically select and generate the optimal visualization method and layout from analysis results. For AI model input/output examples, the input is “topic-classified data,” and the output is “graph, table, or image data with visualization method specification for each topic.” In subsequent processing, the visualization data is rendered by the display unit and stored by the history management unit. Unlike conventional uniform graph display or manual selection of visualization methods, the visualization unit combines computer-specific technical methods such as automatic linkage between topic classification and visualization methods, real-time layout optimization, and automatic generation by AI, thereby greatly improving the comprehensibility and flexibility of visualization of discussion content. Specific application fields include corporate decision support, organization of discussion points in educational settings, case comparison in medical settings, visualization of issues in policy-making workshops, and diverse visualization functions in AI-based automatic minutes generation services.

The visualization unit can estimate emotions during a conversation and determine the priority of visualization based on the estimated emotions. For example, the visualization unit estimates emotions during a conversation and, if the emotions are heightened, prioritizes the visualization of important information. The visualization unit may use an emotion estimation algorithm to estimate emotions during a conversation. The emotion estimation algorithm may utilize, for example, facial expression recognition, voice analysis, and text analysis. The emotion estimation algorithm takes voice data and text data from the conversation as input and outputs an emotion score. For example, the visualization unit, when emotions are heightened, adjusts the priority of visualization content to prioritize important information. When emotions are calm, the visualization unit visualizes in the normal order. Furthermore, when emotions are unstable, the visualization unit can adjust the priority of information for visualization. For example, when emotions are unstable, the visualization unit dynamically adjusts the priority of visualization content to provide optimal visualization. By determining the priority of visualization based on emotions, important information is prioritized for visualization. Emotion estimation may be implemented using an emotion engine or generative AI, such as text generation AI (e.g., LLM) or multimodal generative AI, but is not limited to these examples. Some or all of the above-described processing in the visualization unit may be performed using AI or without using AI. For example, the visualization unit may input emotion data to generative AI and have the generative AI execute the determination of visualization priority. Specifically, the visualization unit simultaneously receives as input 16 kHz, 16 bit, monaural PCM format voice data, 128×128 pixel RGB facial image data, and text-converted utterance data received from the speech recognition unit or analysis unit. The visualization unit performs spectrogram conversion and MFCC extraction on voice data, facial region detection and facial feature point extraction on facial image data, and context vectorization using a pre-trained large language model on text data. These feature quantities are input to a multimodal emotion estimation model that combines multilayer perceptrons, convolutional neural networks, recurrent neural networks, Transformer models, etc., and the model outputs “emotion scores” (e.g., positive 0.85, negative 0.10, neutral 0.05) and “emotion labels” (e.g., anger, joy, sadness, etc.). When the emotion score is heightened, the visualization unit assigns priority scores to analysis result data (e.g., key points for each topic, important decision items, unresolved issues, etc.) received from the analysis unit or history management unit, and automatically adjusts the display order to visualize important information at the top. When emotions are calm, the visualization unit maintains the normal visualization order (e.g., chronological order, topic order), and when emotions are unstable, it dynamically recalculates visualization priority according to the fluctuation range of emotion scores and the emotional tendency of each utterance, enabling users to immediately grasp information that requires attention. For AI model input/output examples, the input is “multimodal data of voice, image, text+analysis result data,” and the output is “emotion score, emotion label, analysis result data with visualization priority.” In subsequent processing, the visualization unit draws graphs and tables with important information placed at the top in real time using HTML5, CSS3, JavaScript, etc., based on the received priority information. Unlike conventional subjective judgment of information priority by humans or manual adjustment of visualization order, the visualization unit combines computer-specific technical methods such as multimodal emotion estimation in high-dimensional feature space, complex emotion analysis using deep learning models, and real-time control of visualization priority, thereby achieving technical effects such as optimization of information presentation according to emotions and improvement of user experience. Specific application fields include immediate emphasis visualization of urgent topics in corporate online meetings, presentation of key points according to students' emotional changes in educational settings, prioritized visualization of important matters based on emotional exchanges between patients and doctors in remote medical conferences, organization of issues based on emotion analysis in policy-making workshops, and emotion-priority graph generation functions in AI-based automatic minutes generation services.

The visualization unit can optimize visualization content for the user's device and display it. For example, the visualization unit optimizes visualization content for the user's device and displays it for smartphones. The visualization unit can change the layout of visualization content according to the screen size of the user's device. For example, the visualization unit adjusts visualization content to fit the screen size of a smartphone. The visualization unit can also optimize visualization content for tablets. For example, the visualization unit adjusts visualization content to fit the screen size of a tablet. Furthermore, the visualization unit can optimize visualization content for desktops. For example, the visualization unit adjusts visualization content to fit the screen size of a desktop. By optimizing for the device, users can check information from various devices. Some or all of the above-described processing in the visualization unit may be performed using AI or without using AI. For example, the visualization unit may input device information to generative AI and have the generative AI execute the optimization of visualization content. Specifically, the visualization unit analyzes device information (e.g., screen resolution, pixel density, OS type, browser type, input method, etc.) obtained from the user's access terminal in real time and links it to the visualization control module. The visualization unit receives visualization data (e.g., graphs, tables, annotated images, etc.) from the analysis unit or history management unit as input and dynamically applies layout (e.g., responsive design, automatic adjustment of the number of columns, card-type UI, optimization for touch operation, etc.), font size, button placement, and interaction methods (e.g., swipe, pinch-in/out, etc.) using web technologies such as HTML5, CSS3, JavaScript, WebGL, etc., according to device information. For smartphones, the visualization unit optimizes for vertical layout and touch operation; for tablets, it optimizes for two-column or grid layout; and for desktops, it optimizes for multi-window display and mouse operation. When the user switches devices or changes screen size, the visualization unit immediately redraws the visualization content to maintain consistency and comfort in the user experience. The visualization unit may use AI models (e.g., generative large language models) to learn from past device usage history and user operation patterns and automatically propose optimal layouts and UI optimization. For AI model input/output examples, the input is “device information+visualization data,” and the output is “optimized HTML/CSS/JS code” or “layout parameters.” In subsequent processing, the optimized visualization content is immediately reflected in user interfaces such as web browsers or AR glasses. Unlike conventional uniform screen display or manual device optimization, the visualization unit combines computer-specific technical methods such as device information linkage, real-time visualization optimization, and automatic layout proposals by AI, thereby achieving technical effects such as optimized visualization experience and improved convenience for each user and device. Specific application fields include meeting systems in corporate BYOD environments, multi-device learning support in educational settings, information sharing among tablets, smartphones, and desktops in medical settings, optimized display for field terminals in policy-making workshops, and cross-device visualization functions in AI-based automatic minutes generation services.

The visualization unit can display visualization content in cooperation with other applications. For example, the visualization unit cooperates with other applications to display visualization content in a schedule management app. The visualization unit can share data with other applications using APIs. For example, the visualization unit sends visualization content to a schedule management app and reflects it in the schedule. The visualization unit can also cooperate with a project management app. For example, the visualization unit sends visualization content to a project management app and reflects it in the progress of the project. Furthermore, the visualization unit can cooperate with a messaging app. For example, the visualization unit sends visualization content to a messaging app and displays it as a message. By cooperating with other applications, information sharing becomes easier. Some or all of the above-described processing in the visualization unit may be performed using AI or without using AI. For example, the visualization unit may input API information to generative AI and have the generative AI execute cooperation with other applications. Specifically, the visualization unit manages API information for external application cooperation (e.g., REST API endpoints, OAuth authentication tokens, data schema definitions, etc.) and receives visualization data (e.g., meeting summary graphs, minutes charts, task progress charts, schedule timelines, etc.) from the analysis unit or history management unit as input. The visualization unit automatically converts data formats (e.g., JSON, XML, CSV, etc.) based on API specifications and sends data according to the requirements of external applications. For schedule management apps, the visualization unit registers meeting schedules and tasks as calendar events; for project management apps, it reflects the progress of discussions and task progress on project boards; and for messaging apps, it sends key points and alerts as chat messages. The visualization unit monitors the success of API cooperation and data synchronization status, and automatically performs retransmission or user notification in case of errors. The visualization unit may use AI models (e.g., generative large language models) to automate data mapping and cooperation flow optimization for each external application, and propose cooperation or automatic settings according to the user's workflow. For AI model input/output examples, the input is “API information+visualization data,” and the output is “data structure for external applications” or “cooperation flow control parameters.” In subsequent processing, the cooperated data is immediately reflected in external applications, and users can seamlessly utilize information across multiple business tools. Unlike conventional manual data transfer or application cooperation, the visualization unit combines computer-specific technical methods such as automatic API cooperation, data format conversion, and cooperation flow optimization by AI, thereby achieving technical effects such as improved efficiency of information sharing and automation of business processes. Specific application fields include groupware cooperation in companies, learning management system cooperation in educational settings, electronic medical record and scheduler cooperation in medical settings, project management tool cooperation in policy-making workshops, and external application cooperation visualization functions in AI-based automatic minutes generation services.

The storage unit can estimate emotions during a conversation and determine the priority of data to be stored based on the estimated emotions. For example, the storage unit estimates emotions during a conversation and, if the emotions are heightened, prioritizes the storage of important information. The storage unit may use an emotion estimation algorithm to estimate emotions during a conversation. The emotion estimation algorithm may utilize, for example, facial expression recognition, voice analysis, and text analysis. The emotion estimation algorithm takes voice data and text data from the conversation as input and outputs an emotion score. For example, the storage unit, when emotions are heightened, adjusts the priority of stored data to prioritize important information. When emotions are calm, the storage unit stores data in the normal order. Furthermore, when emotions are unstable, the storage unit can adjust the priority of information for storage. For example, when emotions are unstable, the storage unit dynamically adjusts the priority of stored data to provide optimal storage. By determining the priority of stored data based on emotions, important information is prioritized for storage. Emotion estimation may be implemented using an emotion engine or generative AI, such as text generation AI (e.g., LLM) or multimodal generative AI, but is not limited to these examples. Some or all of the above-described processing in the storage unit may be performed using AI or without using AI. For example, the storage unit may input emotion data to generative AI and have the generative AI execute the determination of storage data priority. Specifically, the storage unit simultaneously receives as input 16 kHz, 16 bit, monaural PCM format voice data output from the speech recognition unit, facial image data (e.g., 128×128 pixel RGB images) obtained from a webcam, and text-converted utterance data (e.g., “I absolutely want this proposal to pass!”). The storage unit performs spectrogram conversion and MFCC extraction on voice data, facial region detection and facial feature point extraction (e.g., 68 landmarks for eyes, mouth, and eyebrows) on facial image data, and context vectorization using a pre-trained large language model on text data. These feature quantities are input to a multimodal emotion estimation model that combines multilayer perceptrons, convolutional neural networks, recurrent neural networks, Transformer models, etc. The storage unit obtains model outputs such as “emotion scores” (e.g., positive 0.85, negative 0.10, neutral 0.05) and “emotion labels” (e.g., anger, joy, sadness, etc.). Input examples include “high-pitched speech with anger+grim facial image+text ‘Why is this happening?’” or “calm voice+smiling facial image+‘Let's proceed with this proposal,’” and output examples are “anger: 0.92” or “joy: 0.80.” When the emotion score is heightened, the storage unit assigns priority scores to analysis result data (e.g., key points for each topic, important decision items, unresolved issues, etc.) received from the analysis unit or history management unit, and automatically adjusts the storage order to store important information at the top. When emotions are calm, the storage unit maintains the normal storage order (e.g., chronological order, topic order), and when emotions are unstable, it dynamically recalculates storage priority according to the fluctuation range of emotion scores and the emotional tendency of each utterance, enabling users to immediately store information that should be referenced later. For AI model input/output examples, the input is “multimodal data of voice, image, text+analysis result data,” and the output is “emotion score, emotion label, analysis result data with storage priority.” In subsequent processing, the storage unit stores important information at the top in NoSQL databases or time-series DBs based on the received priority information and immediately provides it to the history management unit or analysis unit when resuming. Unlike conventional subjective judgment of information priority by humans or manual adjustment of storage order, the storage unit combines computer-specific technical methods such as multimodal emotion estimation in high-dimensional feature space, complex emotion analysis using deep learning models, and real-time control of storage priority, thereby achieving technical effects such as optimization of information storage according to emotions and improvement of user experience. Specific application fields include immediate storage of urgent topics in corporate online meetings, storage of key points according to students' emotional changes in educational settings, prioritized storage of important matters based on emotional exchanges between patients and doctors in remote medical conferences, storage of issues based on emotion analysis in policy-making workshops, and emotion-priority history storage functions in AI-based automatic minutes generation services.

The storage unit can associate stored data with the user's past discussion history. For example, the storage unit associates stored data with the user's past discussion history to facilitate searching. The storage unit may use natural language processing technology to analyze past discussion history. Natural language processing technology may utilize, for example, morphological analysis, grammatical analysis, and semantic analysis. Natural language processing technology takes text data as input and outputs analysis results for understanding past discussion history. For example, the storage unit associates stored data with the user's past discussion history and automatically displays related information. The storage unit can also associate stored data with the user's past discussion history to make it easier to grasp the progress of discussions. Furthermore, the storage unit can update stored data in real time in association with past discussion history. For example, the storage unit automatically updates stored data according to the progress of the conversation and associates it with past discussion history. By associating stored data with past discussion history, searching and referencing become easier. Some or all of the above-described processing in the storage unit may be performed using AI or without using AI. For example, the storage unit may input past discussion history data to generative AI and have the generative AI execute the association of stored data. Specifically, the storage unit obtains structured data such as past utterance content, topics, participants, timestamps, emotion scores, etc., from a user-specific past discussion history database (e.g., NoSQL DB, full-text search engine, time-series DB, etc.). The storage unit receives new utterance data (e.g., utterance content, speaker, topic label, emotion score, etc.) from the speech recognition unit or analysis unit as input and applies natural language processing techniques (morphological analysis, syntactic analysis, semantic analysis, topic extraction, similarity calculation, etc.) to calculate the degree of association with past discussion history. For example, the storage unit quantifies the relevance between new utterances and past utterances using cosine similarity or vector distance, and if the relevance is high, automatically generates stored data with link information or annotation. The storage unit stores associated data as structured data (e.g., JSON format “utterance ID, related history ID, relevance score, annotation,” etc.) in the database. When new utterances or topics are added according to the progress of the conversation, the storage unit updates association information in real time and immediately reflects it in the history management unit or search interface. The storage unit may use AI models (e.g., large language models or similarity estimation AI) to input past discussion history data (e.g., “April 2023 discussion on proposal A,” “cost reduction topic,” etc.) and output association information with stored data (e.g., related history ID, relevance score, annotation text, etc.). In subsequent processing, associated stored data is utilized in search UIs or navigation when resuming discussions, allowing users to instantly refer to similar past discussions or related topics. Unlike conventional manual management of discussion history or simple chronological storage, the storage unit combines computer-specific technical methods such as semantic feature extraction in high-dimensional vector space, real-time relevance calculation, and automatic annotation/linking by AI, thereby greatly improving the searchability, referability, and navigability of discussion history. Specific application fields include search of meeting records in companies, reference to past discussions in educational settings, linkage of case histories in medical conferences, automatic suggestion of past issues in policy-making workshops, and history navigation functions in AI-based automatic minutes generation services.

The storage unit can update stored data in real time to reflect the latest information. For example, the storage unit updates stored data in real time to reflect the latest information. The storage unit may use natural language processing technology to analyze the progress of a conversation and update stored data. Natural language processing technology may utilize, for example, morphological analysis, grammatical analysis, and semantic analysis. Natural language processing technology takes text data as input and outputs analysis results for understanding the progress. For example, the storage unit updates stored data in real time according to the progress of the conversation to reflect the latest information. The storage unit can also highlight important points. For example, the storage unit automatically highlights important points according to the progress of the conversation. Furthermore, the storage unit can indicate the direction of the discussion. For example, the storage unit creates stored data indicating the direction of the discussion according to the progress of the conversation. By updating stored data in real time, the latest information is immediately reflected. Some or all of the above-described processing in the storage unit may be performed using AI or without using AI. For example, the storage unit may input analysis results to generative AI and have the generative AI execute the update of stored data. Specifically, the storage unit receives as input a stream of text data (e.g., JSON format utterance data updated per utterance) and analysis result data (e.g., topic labels, comparison items, emotion scores, important keywords, etc.) sequentially from the speech recognition unit or analysis unit. The storage unit links multiple natural language processing modules such as morphological analysis, syntactic analysis, semantic analysis, topic extraction, comparison expression detection, and emotion analysis in a pipeline configuration, and generates and updates stored data for each utterance unit or time window. The storage unit manages analysis results (e.g., topic A: 5 utterances, emotion score 0.8, important point: cost reduction, etc.) in chronological order, aggregates the state of the ongoing discussion (e.g., current topic, number of utterances per speaker, trends in emotional changes, etc.) in real time, and immediately reflects them in stored data. When a new topic appears according to the progress of the conversation, the storage unit immediately updates topic labels and storage priority, and generates important points (e.g., new issues, signs of consensus formation, occurrence of conflicts, etc.) as data with highlight flags. The storage unit automatically determines the direction of the discussion (e.g., ratio of agreement/disagreement, tendency of issue diffusion/convergence, etc.) and notifies the history management unit or analysis unit when resuming. For AI model input/output examples, the input is “utterance stream+analysis result data,” and the output is “real-time updated stored data+data with highlight flags.” In subsequent processing, the updated stored data is immediately reflected in NoSQL databases or time-series DBs and provided to the history management unit or analysis unit when resuming. Unlike conventional manual minute creation or manual progress management by humans, the storage unit combines computer-specific technical methods such as real-time data stream analysis, state estimation in high-dimensional feature space, automatic flagging by AI, and pipeline-type data flow control, thereby achieving technical effects such as immediate reflection of the latest information and efficient management of discussion progress. Specific application fields include progress management in corporate online meetings, visualization of discussion progress in educational settings, tracking of discussion progress in medical conferences, management of issue progress in policy-making workshops, and real-time history update functions in AI-based automatic minutes generation services.

The storage unit can estimate emotions during a conversation and adjust the display method of stored data based on the estimated emotions. For example, the storage unit estimates emotions during a conversation and, if the emotions are heightened, highlights the stored data. The storage unit may use an emotion estimation algorithm to estimate emotions during a conversation. The emotion estimation algorithm may utilize, for example, facial expression recognition, voice analysis, and text analysis. The emotion estimation algorithm takes voice data and text data from the conversation as input and outputs an emotion score. For example, the storage unit, when emotions are heightened, adjusts the display method to highlight stored data. When emotions are calm, the storage unit displays stored data in the normal way. Furthermore, when emotions are unstable, the storage unit can adjust the display of stored data. For example, when emotions are unstable, the storage unit dynamically adjusts the display method of stored data to provide optimal display. By adjusting the display method based on emotions, more appropriate display becomes possible. Emotion estimation may be implemented using an emotion engine or generative AI, such as text generation AI (e.g., LLM) or multimodal generative AI, but is not limited to these examples. Some or all of the above-described processing in the storage unit may be performed using AI or without using AI. For example, the storage unit may input emotion data to generative AI and have the generative AI execute the adjustment of the display method of stored data. Specifically, the storage unit simultaneously receives as input 16 kHz, 16 bit, monaural PCM format voice data output from the speech recognition unit, facial image data (e.g., 128×128 pixel RGB images) obtained from a webcam, and text-converted utterance data (e.g., “I absolutely want this proposal to pass!”). The storage unit performs spectrogram conversion and MFCC extraction on voice data, facial region detection and facial feature point extraction (e.g., 68 landmarks for eyes, mouth, and eyebrows) on facial image data, and context vectorization using a pre-trained large language model on text data. These feature quantities are input to a multimodal emotion estimation model that combines multilayer perceptrons, convolutional neural networks, recurrent neural networks, Transformer models, etc. The storage unit obtains model outputs such as “emotion scores” (e.g., positive 0.85, negative 0.10, neutral 0.05) and “emotion labels” (e.g., anger, joy, sadness, etc.). Input examples include “high-pitched speech with anger+grim facial image+text ‘Why is this happening?’” or “calm voice+smiling facial image+‘Let's proceed with this proposal,’” and output examples are “anger: 0.92” or “joy: 0.80.” When the emotion score is heightened, the storage unit automatically applies display methods (e.g., background color change, font size enlargement, animation, highlight frame display, etc.) to stored data so that users can intuitively grasp information that requires attention. When emotions are calm, the storage unit maintains the standard display format (e.g., standard colors, standard font size), and when emotions are unstable, it dynamically recalculates the display method according to the fluctuation range of emotion scores and the emotional tendency of each utterance, maintaining consistency and comfort in the user experience. For AI model input/output examples, the input is “multimodal data of voice, image, text+stored data,” and the output is “emotion score, emotion label, stored data with display method specification.” In subsequent processing, stored data is linked to the history management unit or display unit when resuming, and users can immediately check highlighted or normal display according to emotions. Unlike conventional subjective emotion judgment by humans or manual adjustment of display formats, the storage unit combines computer-specific technical methods such as multimodal emotion estimation in high-dimensional feature space, complex emotion analysis using deep learning models, and real-time control of display methods, thereby achieving technical effects such as optimization of stored data display according to emotions and improvement of user experience. Specific application fields include highlighted storage display of urgent topics in corporate online meetings, emphasis of key points according to students' emotional changes in educational settings, highlighted storage display of important matters based on emotional exchanges between patients and doctors in remote medical conferences, emphasis of discussion points based on emotion analysis in policy-making workshops, and emotion-highlighted history storage functions in AI-based automatic minutes generation services.

The storage unit can optimize stored data for the user's device. For example, the storage unit optimizes stored data for the user's device and stores it for smartphones. The storage unit can change the layout of stored data according to the screen size of the user's device. For example, the storage unit adjusts stored data to fit the screen size of a smartphone. The storage unit can also optimize stored data for tablets. For example, the storage unit adjusts stored data to fit the screen size of a tablet. Furthermore, the storage unit can optimize stored data for desktops. For example, the storage unit adjusts stored data to fit the screen size of a desktop. By optimizing for the device, users can check information from various devices. Some or all of the above-described processing in the storage unit may be performed using AI or without using AI. For example, the storage unit may input device information to generative AI and have the generative AI execute the optimization of stored data. Specifically, the storage unit analyzes device information (e.g., screen resolution, pixel density, OS type, browser type, input method, etc.) obtained from the user's access terminal in real time and links it to the storage data control module. The storage unit receives stored data (e.g., minutes text, graph images, annotated diagrams, etc.) from the analysis unit or history management unit as input and dynamically applies storage formats (e.g., text, image, audio, HTML, PDF, SVG, PNG, etc.), layout (e.g., responsive design, automatic adjustment of the number of columns, card-type UI, optimization for touch operation, etc.), and file size compression methods (e.g., WebP, HEIF, MP3, AAC, etc.) according to device information. For smartphones, the storage unit optimizes storage formats for vertical layout and touch operation; for tablets, it optimizes for two-column or grid layout; and for desktops, it optimizes for multi-window display and high-resolution image storage. When the user switches devices or changes screen size, the storage unit immediately regenerates stored data to maintain consistency and comfort in the user experience. The storage unit may use AI models (e.g., generative large language models) to learn from past device usage history and user operation patterns and automatically propose optimal storage formats, layouts, and file compression/conversion. For AI model input/output examples, the input is “device information+stored data,” and the output is “optimized storage file” or “storage layout parameters.” In subsequent processing, the optimized stored data is immediately saved to the user's local storage or cloud storage and utilized for resumption or reference on other devices. Unlike conventional uniform storage formats or manual device optimization, the storage unit combines computer-specific technical methods such as device information linkage, real-time storage optimization, and automatic layout/file conversion proposals by AI, thereby achieving technical effects such as optimized storage experience and improved convenience for each user and device. Specific application fields include meeting record storage in corporate BYOD environments, multi-device learning history storage in educational settings, information sharing among tablets, smartphones, and desktops in medical settings, optimized storage for field terminals in policy-making workshops, and cross-device storage functions in AI-based automatic minutes generation services.

The storage unit can store data in cooperation with other applications. For example, the storage unit cooperates with other applications to store data in a schedule management app. The storage unit can share data with other applications using APIs. For example, the storage unit sends stored data to a schedule management app and reflects it in the schedule. The storage unit can also cooperate with a project management app. For example, the storage unit sends stored data to a project management app and reflects it in the progress of the project. Furthermore, the storage unit can cooperate with a messaging app. For example, the storage unit sends stored data to a messaging app and displays it as a message. By cooperating with other applications, information sharing becomes easier. Some or all of the above-described processing in the storage unit may be performed using AI or without using AI. For example, the storage unit may input API information to generative AI and have the generative AI execute cooperation with other applications. Specifically, the storage unit manages API information for external application cooperation (e.g., REST API endpoints, OAuth authentication tokens, data schema definitions, etc.) and receives stored data (e.g., meeting summary, minutes, task list, schedule information, etc.) from the analysis unit or history management unit as input. The storage unit automatically converts data formats (e.g., JSON, XML, CSV, etc.) based on API specifications and sends data according to the requirements of external applications. For schedule management apps, the storage unit registers meeting schedules and tasks as calendar events; for project management apps, it reflects the progress of discussions and task progress on project boards; and for messaging apps, it sends key points and alerts as chat messages. The storage unit monitors the success of API cooperation and data synchronization status, and automatically performs retransmission or user notification in case of errors. The storage unit may use AI models (e.g., generative large language models) to automate data mapping and cooperation flow optimization for each external application, and propose cooperation or automatic settings according to the user's workflow. For AI model input/output examples, the input is “API information+stored data,” and the output is “data structure for external applications” or “cooperation flow control parameters.” In subsequent processing, the cooperated stored data is immediately reflected in external applications, and users can seamlessly utilize information across multiple business tools. Unlike conventional manual data transfer or application cooperation, the storage unit combines computer-specific technical methods such as automatic API cooperation, data format conversion, and cooperation flow optimization by AI, thereby achieving technical effects such as improved efficiency of information sharing and automation of business processes. Specific application fields include groupware cooperation in companies, learning management system cooperation in educational settings, electronic medical record and scheduler cooperation in medical settings, project management tool cooperation in policy-making workshops, and external application cooperation storage functions in AI-based automatic minutes generation services.

The system according to the embodiment is not limited to the examples described above and can be variously modified as follows. Specifically, the system adopts a modular design for each component (analysis unit, display unit, visualization unit, storage unit, etc.), enabling flexible addition, deletion, and expansion of functions according to user requirements and operational environments. The system is designed to accommodate various technical variations, such as replacement of AI model types (e.g., large language models, convolutional neural networks, recurrent neural networks, Transformer models, etc.), replacement of trained parameters, changes in feature extraction algorithms, selection of database structures (e.g., NoSQL, time-series DB, graph DB, etc.), and upgrades of web technologies (e.g., HTML5, CSS3, JavaScript, WebGL, etc.). By standardizing the input/output interfaces of AI models, the system can easily add new input data types such as voice, image, text, sensor data, etc., and expand output formats (e.g., scores, labels, structured data, graph data for visualization, etc.). The system supports deployment to different hardware configurations such as cloud environments, on-premises environments, and edge devices, and can be optimized for hardware such as parallel computing clusters using GPUs or FPGA accelerators. By expanding API cooperation functions, the system can realize data cooperation and workflow integration with external schedule management apps, project management tools, messaging services, learning management systems, electronic medical records, etc. To enhance the customizability of the user interface, the system can add accessibility support (e.g., voice reading, color vision diversity support, magnified display, etc.), multilingual support, real-time translation functions, AR/VR device support, etc. The system can also incorporate functions such as data encryption, access control, and audit log recording according to security requirements. With such flexible modifiability, the system not only automates human tasks but also achieves technical effects such as extensibility, maintainability, and operational efficiency of computer technology itself. Specific application fields include support for various types of meetings in companies, individualized learning support in educational settings, multidisciplinary collaboration conferences in medical settings, management of diverse issues in policy-making workshops, customized provision of AI-based automatic minutes generation services, and construction of discussion analysis platforms in research institutions.

The analysis unit, when analyzing conversation content, can measure the frequency and duration of utterances by participants and evaluate the balance of the discussion. For example, the analysis unit counts the number of utterances by each participant and detects bias in utterances. The analysis unit can also measure the duration of utterances by each participant and detect bias in utterance time. Furthermore, the analysis unit evaluates the balance of the discussion based on data such as utterance frequency and duration, and can display an alert if the balance is not maintained. This enables support for maintaining the balance of the discussion. Specifically, the analysis unit receives utterance data (e.g., text data with speaker ID and timestamp) from the speech recognition unit as input, increments the utterance count for each speaker ID per utterance, and calculates utterance duration (in seconds) from the start and end times of utterances. The analysis unit generates utterance count vectors for all participants (e.g., participant A: 12 times, B: 3 times, C: 7 times, etc.) and utterance duration vectors (e.g., A: 300 seconds, B: 45 seconds, C: 120 seconds, etc.), and calculates statistical indicators such as standard deviation, max-min ratio, and Gini coefficient to quantitatively evaluate the degree of bias in utterances. The analysis unit determines whether the utterance count or duration exceeds thresholds (e.g., ±2 σ from the mean) using rule-based or AI models (e.g., anomaly detection autoencoders, clustering models, etc.), and generates an “utterance balance alert” flag if bias is significant. For AI model input/output examples, the input is “utterance data with speaker ID and timestamp,” and the output is “utterance count and duration vectors, balance evaluation score, and alert flag.” Input examples include “A: 10 times/200 seconds, B: 2 times/30 seconds, C: 8 times/100 seconds,” and output examples are “balance score: 0.65 (high bias), alert: ON.” In subsequent processing, the display unit draws a graph of utterance balance and a bias warning message in real time based on the received alert information. Unlike conventional subjective judgment of discussion balance or manual aggregation by humans, the analysis unit combines computer-specific technical methods such as automatic aggregation of utterance data, statistical analysis, and anomaly detection by AI, thereby achieving technical effects such as objective evaluation of discussion balance and real-time support for correcting bias. Specific application fields include equalization of speaking opportunities in corporate meetings, evaluation of student participation in educational settings, management of utterance balance among multiple professions in medical conferences, monitoring of stakeholder utterances in policy-making workshops, and balance alert functions in AI-based automatic minutes generation services.

The analysis unit, when analyzing conversation content, can evaluate the importance of topics in the conversation and prioritize the analysis of important topics. For example, the analysis unit calculates an importance score for each topic in the conversation and prioritizes the analysis of topics with high importance scores. The analysis unit can also highlight important topics based on the importance score. Furthermore, the analysis unit can update the importance score in real time and dynamically adjust the analysis priority according to the progress of the conversation. This enables analysis focused on important topics. Specifically, the analysis unit uses natural language processing techniques (e.g., morphological analysis, syntactic analysis, semantic analysis, topic extraction algorithms such as LDA, k-means clustering, etc.) to automatically extract topic labels from utterance data and aggregates features such as utterance count, utterance duration, keyword frequency, emotion score, etc., for each topic. The analysis unit synthesizes these features with weights (e.g., utterance count×0.4+emotion score×0.3+keyword frequency×0.3, etc.) to calculate an importance score (e.g., 0.0-1.0) for each topic. The analysis unit prioritizes the analysis of topics whose importance score exceeds a threshold (e.g., 0.7 or higher) and adds “important topic” flags or highlight metadata (e.g., HTML tags, color specifications, etc.) to the analysis result data. When new topics appear or features such as utterance count or emotion score change according to the progress of the conversation, the analysis unit recalculates the importance score in real time and dynamically updates the analysis priority. For AI model input/output examples, the input is “utterance data+topic classification data,” and the output is “importance score for each topic+analysis result with highlight flags.” Input examples include “topic A: 10 utterances, emotion 0.8; topic B: 2 utterances, emotion 0.3,” and output examples are “A: importance 0.85, highlight ON; B: importance 0.25, highlight OFF.” In subsequent processing, the display unit or visualization unit draws emphasized key points or color-coded graphs in real time based on the received important topic information. Unlike conventional subjective judgment of topic importance or manual adjustment of analysis order by humans, the analysis unit combines computer-specific technical methods such as quantitative evaluation based on features, dynamic priority control by AI, and real-time highlighting, thereby achieving technical effects such as focused analysis of important topics and optimization of information presentation. Specific application fields include extraction of important agenda items in corporate decision-making meetings, emphasis of key points in educational settings, priority analysis of urgent cases in medical conferences, priority management of issues in policy-making workshops, and important topic highlighting functions in AI-based automatic minutes generation services.

The analysis unit, when analyzing conversation content, can take into account the expertise and experience of participants and customize the analysis results. For example, the analysis unit obtains each participant's field of expertise and years of experience from a database and reflects them in the analysis results. The analysis unit can also display analysis results individually based on expertise and experience. Furthermore, the analysis unit can display analysis results by group based on expertise and experience. This enables analysis that takes into account the expertise and experience of participants. Specifically, the analysis unit obtains attribute information such as field of expertise (e.g., mechanical engineering, business strategy, clinical medicine, etc.), years of experience (e.g., 5 years, 15 years, etc.), position, and qualifications for each participant from a user profile database or pre-survey data and manages it in association with utterance data. The analysis unit receives utterance data (e.g., text with speaker ID) as input and generates structured data (e.g., JSON format “utterance content, speaker ID, field of expertise, years of experience,” etc.) with attribute information for each speaker. The analysis unit applies natural language processing techniques (morphological analysis, syntactic analysis, semantic analysis, etc.) and combines features of utterance content with participant attributes for analysis. As customization processing based on attribute information, the analysis unit executes rule-based or AI model-based display control, such as “emphasize key points for decision-making for managers,” “display technical details for technical staff,” or “add annotations for basic terms for newcomers.” The analysis unit also supports group-based display of analysis results, aggregating and visualizing utterance trends and discussion balance by department or project. When new participants join or attribute information is updated according to the progress of the conversation, the analysis unit updates the customization of analysis results in real time and sends it to the display unit. For AI model input/output examples, the input is “utterance content+speaker attribute data,” and the output is “text with key points emphasized by position,” “data with annotations by field of expertise,” etc., as customized analysis results. In subsequent processing, the display unit optimizes and displays the received customization results for each user. Unlike conventional uniform display of minutes or manual consideration of attributes, the analysis unit combines computer-specific technical methods such as automatic linkage of attribute information and utterance content, real-time customization control, and individual optimization by AI, thereby achieving technical effects such as provision of analysis results optimized for each participant and improvement of discussion efficiency. Specific application fields include role-based key point presentation in multidisciplinary corporate meetings, grade-specific explanation display in educational settings, emphasis of information by specialty in medical conferences, organization of issues by stakeholder in policy-making workshops, and individual optimization functions in AI-based automatic minutes generation services.

The display unit can customize the display of analysis results according to the user's visual preferences. For example, the display unit adjusts the color scheme and font size of the display content based on user settings. The display unit can also change the layout according to the user's visual preferences. Furthermore, the display unit can add animation effects to the display content according to the user's visual preferences. This enables display tailored to the user's visual preferences. Specifically, the display unit obtains customization setting data for each user (e.g., color scheme, font size, layout presets, accessibility settings, etc.) from the user profile database and links it to the display control module. The display unit receives analysis result data (e.g., comparison tables, graphs, annotated text, etc.) from the analysis unit or history management unit as input and dynamically applies color scheme (e.g., dark mode, high contrast, custom color palette), font size (e.g., 12 pt, 16 pt, 20 pt, etc.), and layout (e.g., single column, two columns, card type, grid type, etc.) using web technologies such as HTML5, CSS3, JavaScript, etc., according to user settings. When the user changes settings in real time, the display unit immediately redraws the display content to maintain consistency and comfort in the user experience. The display unit also supports accessibility requirements (e.g., color vision diversity support, voice reading tags, magnified display, etc.), providing optimized display for each user. The display unit may use AI models (e.g., generative large language models) to learn from past user operation history and preference patterns and automatically propose optimal customization and layout optimization. For AI model input/output examples, the input is “user setting data+analysis result data,” and the output is “customized HTML/CSS/JS code” or “optimized layout parameters.” In subsequent processing, the customized display content is immediately reflected in user interfaces such as web browsers or AR glasses. Unlike conventional uniform screen display or manual customization, the display unit combines computer-specific technical methods such as user profile linkage, real-time display optimization, and automatic customization proposals by AI, thereby achieving technical effects such as optimized display experience and improved convenience for each user. Specific application fields include meeting systems for various occupations and age groups in companies, individualized learning support in educational settings, display for visually impaired users in medical settings, optimized display by participant attribute in policy-making workshops, and personalized display functions in AI-based automatic minutes generation services.

The visualization unit, when visualizing the progress of a discussion, can apply different visualization methods for each topic of the discussion. For example, the visualization unit visualizes using different graphs or charts for each topic of the discussion. The visualization unit can also visualize using different colors or fonts for each topic of the discussion. Furthermore, the visualization unit can visualize using different animation effects for each topic of the discussion. This enables appropriate visualization for each topic of the discussion. Specifically, the visualization unit receives topic-classified text data and structured data (e.g., topic A: cost, topic B: ease of introduction, etc.) from the analysis unit as input. The visualization unit applies natural language processing techniques such as morphological analysis, syntactic analysis, semantic analysis, and topic extraction (e.g., LDA, k-means clustering, etc.) to classify each utterance and discussion content into multiple topics. The visualization unit automatically selects the optimal visualization method for each topic (e.g., bar graphs for cost-related topics, tabular format for ease of introduction, line graphs for emotional changes, network diagrams for relationships, flowcharts for processes, etc.) and renders them in real time using HTML5, CSS3, JavaScript, WebGL, etc. The visualization unit dynamically applies color coding, fonts, and animation effects (e.g., fade-in for new topics, bounce display for important topics, etc.) for each topic, enabling users to intuitively grasp the overall picture of the discussion and the differences in issues. The visualization unit may use AI models (e.g., generative large language models or automatic graph generation AI) to automatically select and generate the optimal visualization method and layout from analysis results. For AI model input/output examples, the input is “topic-classified data,” and the output is “graph, table, or image data with visualization method specification for each topic.” In subsequent processing, the visualization data is rendered by the display unit and stored by the history management unit. Unlike conventional uniform graph display or manual selection of visualization methods, the visualization unit combines computer-specific technical methods such as automatic linkage between topic classification and visualization methods, real-time layout optimization, and automatic generation by AI, thereby greatly improving the comprehensibility and flexibility of visualization of discussion content. Specific application fields include corporate decision support, organization of discussion points in educational settings, case comparison in medical settings, visualization of issues in policy-making workshops, and diverse visualization functions in AI-based automatic minutes generation services.

The analysis unit can estimate emotions during a conversation and adjust the display method of analysis results based on the estimated emotions. For example, the analysis unit highlights analysis results when emotions are heightened and displays them normally when emotions are calm. The analysis unit can also dynamically adjust the display method of analysis results when emotions are unstable. Furthermore, the analysis unit can display analysis results in bright colors when emotions are positive and in dark colors when emotions are negative. This enables appropriate display based on emotions. Specifically, the analysis unit simultaneously receives as input 16 kHz, 16 bit, monaural PCM format voice data from the speech recognition unit or history management unit, facial image data (e.g., 128×128 pixel RGB images) obtained from a webcam, and text-converted utterance data (e.g., “I absolutely want this proposal to pass!”). The analysis unit performs spectrogram conversion and MFCC extraction on voice data, facial region detection and facial feature point extraction (e.g., 68 landmarks for eyes, mouth, and eyebrows) on facial image data, and context vectorization using a pre-trained large language model on text data. These feature quantities are input to a multimodal emotion estimation model that combines multilayer perceptrons, convolutional neural networks, recurrent neural networks, Transformer models, etc. The analysis unit obtains model outputs such as “emotion scores” (e.g., positive 0.85, negative 0.10, neutral 0.05) and “emotion labels” (e.g., anger, joy, sadness, etc.). Input examples include “high-pitched speech with anger+grim facial image+text ‘Why is this happening?’” or “calm voice+smiling facial image+‘Let's proceed with this proposal,’” and output examples are “anger: 0.92” or “joy: 0.80.” When the emotion score is heightened, the analysis unit automatically applies display formats (e.g., background color change, font size enlargement, animation, highlight frame display, etc.) to analysis result data (e.g., key points for each topic, important decision items, unresolved issues, etc.) so that users can intuitively grasp information that requires attention. When emotions are calm, the analysis unit maintains the standard display format (e.g., standard colors, standard font size), and when emotions are unstable, it dynamically recalculates the display format according to the fluctuation range of emotion scores and the emotional tendency of each utterance, maintaining consistency and comfort in the user experience. When emotions are positive, the analysis unit automatically applies bright colors (e.g., yellow, green, etc.), and when emotions are negative, it applies dark colors (e.g., red, gray, etc.). For AI model input/output examples, the input is “multimodal data of voice, image, text+analysis result data,” and the output is “emotion score, emotion label, analysis result data with display format specification.” In subsequent processing, the display unit draws highlight or normal display in real time using HTML5, CSS3, JavaScript, etc., based on the received display format information. Unlike conventional subjective emotion judgment by humans or manual adjustment of display formats, the analysis unit combines computer-specific technical methods such as multimodal emotion estimation in high-dimensional feature space, complex emotion analysis using deep learning models, and real-time control of display formats, thereby achieving technical effects such as optimization of display formats according to emotions and improvement of user experience. Specific application fields include highlighted display of urgent topics in corporate online meetings, emphasis of key points according to students' emotional changes in educational settings, highlighted display of important matters based on emotional exchanges between patients and doctors in remote medical conferences, emphasis of discussion points based on emotion analysis in policy-making workshops, and emotion-highlighted summarization functions in AI-based automatic minutes generation services.

The display unit can estimate emotions during a conversation and determine the priority of display content based on the estimated emotions. For example, the display unit prioritizes the display of important information when emotions are heightened and displays content in the normal order when emotions are calm. The display unit can also dynamically adjust the priority of information when emotions are unstable. Furthermore, the display unit can prioritize the display of positive information when emotions are positive and negative information when emotions are negative. This enables appropriate display based on emotions. Specifically, the display unit receives multiple input data for emotion estimation processing. The display unit simultaneously receives as input 16 kHz, 16 bit, monaural PCM format voice data output from the speech recognition unit, facial image data (e.g., 128×128 pixel RGB images) obtained from a webcam, and text-converted utterance data (e.g., “I absolutely want this proposal to pass!”). The display unit performs spectrogram conversion and MFCC extraction on voice data, facial region detection and facial feature point extraction (e.g., 68 landmarks for eyes, mouth, and eyebrows) on facial image data, and context vectorization using a pre-trained large language model on text data. These feature quantities are input to a multimodal emotion estimation model that combines multilayer perceptrons, convolutional neural networks, recurrent neural networks, Transformer models, etc. The display unit obtains model outputs such as “emotion scores” (e.g., positive 0.85, negative 0.10, neutral 0.05) and “emotion labels” (e.g., anger, joy, sadness, etc.). Input examples include “high-pitched speech with anger+grim facial image+text ‘Why is this happening?’” or “calm voice+smiling facial image+‘Let's proceed with this proposal,’” and output examples are “anger: 0.92” or “joy: 0.80.” When the emotion score is heightened, the display unit assigns priority scores to analysis result data (e.g., key points for each topic, important decision items, unresolved issues, etc.) received from the analysis unit or history management unit, and automatically adjusts the display order to display important information at the top. When emotions are calm, the display unit maintains the normal display order (e.g., chronological order, topic order), and when emotions are unstable, it dynamically recalculates display priority according to the fluctuation range of emotion scores and the emotional tendency of each utterance, enabling users to immediately grasp information that requires attention. When emotions are positive, the display unit prioritizes positive information (e.g., consensus items, positive proposals, etc.), and when emotions are negative, it prioritizes negative information (e.g., concerns, opposing opinions, etc.) for top display. For AI model input/output examples, the input is “multimodal data of voice, image, text+analysis result data,” and the output is “emotion score, emotion label, analysis result data with display priority.” In subsequent processing, the display unit draws tables or graphs with important information placed at the top in real time using HTML5, CSS3, JavaScript, etc., based on the received priority information. Unlike conventional subjective judgment of information priority by humans or manual adjustment of display order, the display unit combines computer-specific technical methods such as multimodal emotion estimation in high-dimensional feature space, complex emotion analysis using deep learning models, and real-time control of display priority, thereby achieving technical effects such as optimization of information presentation according to emotions and improvement of user experience. Specific application fields include immediate emphasis display of urgent topics in corporate online meetings, presentation of key points according to students' emotional changes in educational settings, prioritized display of important matters based on emotional exchanges between patients and doctors in remote medical conferences, organization of issues based on emotion analysis in policy-making workshops, and emotion-priority summarization functions in AI-based automatic minutes generation services.

The visualization unit is capable of estimating emotions during a conversation and adjusting the visualization method based on the estimated emotions. For example, the visualization unit may change the visualization method to highlight when emotions are heightened, and use normal display when emotions are calm. Additionally, when emotions are unstable, the visualization unit can dynamically adjust the visualization method. Furthermore, the visualization unit can visualize with bright colors when emotions are positive and with dark colors when emotions are negative. This enables appropriate visualization based on emotions. Specifically, the visualization unit simultaneously receives multiple inputs such as 16 kHz, 16 bit, monaural PCM format audio data received from the speech recognition unit or analysis unit, 128×128 pixel RGB facial image data, and text-converted utterance data (e.g., “I absolutely want this proposal to pass!”). The visualization unit performs spectrogram conversion and MFCC extraction on audio data, facial region detection and facial feature point extraction (e.g., 68 landmarks for eyes, mouth, and eyebrows) on facial image data, and context vectorization using a pre-trained large language model on text data. The visualization unit inputs these features into a multimodal emotion estimation model that combines multilayer perceptrons, convolutional neural networks, recurrent neural networks, Transformer-type models, and others. The visualization unit obtains model outputs such as “emotion scores” (e.g., positive 0.85, negative 0.10, neutral 0.05) and “emotion labels” (e.g., anger, joy, sadness, etc.). Example inputs include “high-pitched speech audio with anger+stern facial image+text such as ‘Why is this happening?’” or “calm voice+smiling facial expression+‘Let's proceed with this proposal,’” and example outputs are “anger: 0.92” or “joy: 0.80.” When the emotion score is heightened, the visualization unit automatically applies design elements to graphs and charts (e.g., emphasizing red background color, enlarging font size, adding animation, displaying highlight frames, etc.) so that users can intuitively grasp information that requires attention. When emotions are calm, the visualization unit maintains the normal visualization format (e.g., standard colors, standard font size), and when emotions are unstable, it dynamically recalculates the visualization method according to the fluctuation range of emotion scores and the emotional tendency of each utterance, maintaining consistency and comfort in the user experience. When emotions are positive, the visualization unit automatically applies bright colors (e.g., yellow, green, etc.), and when negative, dark colors (e.g., red, gray, etc.). As an example of AI model input/output, the input is “multimodal data of audio, image, and text plus analysis result data,” and the output is “graph data with emotion scores, emotion labels, and visualization method specifications.” In subsequent processing, the visualization unit draws highlight or normal displays in real time using HTML5, CSS3, JavaScript, etc., based on the received visualization method information. Unlike conventional subjective emotion judgment by humans or manual adjustment of visualization methods, the visualization unit combines computer-specific technical approaches such as multimodal emotion estimation in high-dimensional feature space, complex emotion analysis using deep learning models, and real-time control of visualization methods, thereby achieving technical effects such as optimization of visualization methods according to emotions and improvement of user experience. Specific application fields include visualization of emotional discussions in corporate online meetings, emphasis of key points according to students' emotional changes in educational settings, highlighting important matters based on emotional exchanges between patients and doctors in remote medical conferences, emphasis of discussion points based on emotion analysis in policy-making workshops, and generation of emotion-highlighted graphs in AI-based automatic minutes generation services.

The storage unit is capable of estimating emotions during a conversation and determining the priority of data to be stored based on the estimated emotions. For example, when emotions are heightened, the storage unit prioritizes the storage of important information, and when emotions are calm, it stores data in the normal order. Additionally, when emotions are unstable, the storage unit can dynamically adjust the priority of information. Furthermore, when emotions are positive, the storage unit prioritizes the storage of positive information, and when emotions are negative, it prioritizes the storage of negative information. This enables appropriate storage based on emotions. Specifically, the storage unit simultaneously receives as input 16 kHz, 16 bit, monaural PCM format audio data output from the speech recognition unit, facial image data obtained from a webcam or the like (e.g., 128×128 pixel RGB images), and text-converted utterance data (e.g., “I absolutely want this proposal to pass!”). The storage unit performs spectrogram conversion and MFCC extraction on audio data, facial region detection and facial feature point extraction (e.g., 68 landmarks for eyes, mouth, and eyebrows) on facial image data, and context vectorization using a pre-trained large language model on text data. The storage unit inputs these features into a multimodal emotion estimation model that combines multilayer perceptrons, convolutional neural networks, recurrent neural networks, Transformer-type models, and others. The storage unit obtains model outputs such as “emotion scores” (e.g., positive 0.85, negative 0.10, neutral 0.05) and “emotion labels” (e.g., anger, joy, sadness, etc.). Example inputs include “high-pitched speech audio with anger+stern facial image+text such as ‘Why is this happening?’” or “calm voice+smiling facial expression+‘Let's proceed with this proposal,’” and example outputs are “anger: 0.92” or “joy: 0.80.” When the emotion score is heightened, the storage unit automatically assigns priority scores to analysis result data (e.g., key points for each topic, important decision items, unresolved issues, etc.) received from the analysis unit or history management unit, and automatically adjusts the storage order so that important information is stored at the top. When emotions are calm, the storage unit maintains the normal storage order (e.g., chronological order, topic order), and when emotions are unstable, it dynamically recalculates the storage priority according to the fluctuation range of emotion scores and the emotional tendency of each utterance, enabling immediate storage of information that should be referenced later by the user. When emotions are positive, the storage unit prioritizes positive information (e.g., agreements, positive proposals, etc.), and when negative, negative information (e.g., concerns, opposing opinions, etc.) for top-level storage. As an example of AI model input/output, the input is “multimodal data of audio, image, and text plus analysis result data,” and the output is “analysis result data with emotion scores, emotion labels, and storage priority.” In subsequent processing, the storage unit stores important information at the top in NoSQL-type databases or time-series DBs based on the received priority information, and immediately provides it to the history management unit or analysis unit when resuming. Unlike conventional subjective judgment of information priority by humans or manual adjustment of storage order, the storage unit combines computer-specific technical approaches such as multimodal emotion estimation in high-dimensional feature space, complex emotion analysis using deep learning models, and real-time control of storage priority, thereby achieving technical effects such as optimization of information storage according to emotions and improvement of user experience. Specific application fields include immediate storage of urgent topics in corporate online meetings, storage of key points according to students' emotional changes in educational settings, prioritized storage of important matters based on emotional exchanges between patients and doctors in remote medical conferences, storage of discussion points based on emotion analysis in policy-making workshops, and emotion-prioritized history storage functions in AI-based automatic minutes generation services.

The storage unit is capable of estimating emotions during a conversation and adjusting the display method of stored data based on the estimated emotions. For example, when emotions are heightened, the storage unit highlights the stored data, and when emotions are calm, it uses normal display. Additionally, when emotions are unstable, the storage unit can dynamically adjust the display method of stored data. Furthermore, when emotions are positive, the storage unit displays stored data in bright colors, and when emotions are negative, it displays stored data in dark colors. This enables appropriate display based on emotions. Specifically, the storage unit simultaneously receives as input 16 kHz, 16 bit, monaural PCM format audio data output from the speech recognition unit, facial image data obtained from a webcam or the like (e.g., 128×128 pixel RGB images), and text-converted utterance data (e.g., “I absolutely want this proposal to pass!”). The storage unit performs spectrogram conversion and MFCC extraction on audio data, facial region detection and facial feature point extraction (e.g., 68 landmarks for eyes, mouth, and eyebrows) on facial image data, and context vectorization using a pre-trained large language model on text data. The storage unit inputs these features into a multimodal emotion estimation model that combines multilayer perceptrons, convolutional neural networks, recurrent neural networks, Transformer-type models, and others. The storage unit obtains model outputs such as “emotion scores” (e.g., positive 0.85, negative 0.10, neutral 0.05) and “emotion labels” (e.g., anger, joy, sadness, etc.). Example inputs include “high-pitched speech audio with anger+stern facial image+text such as ‘Why is this happening?’” or “calm voice+smiling facial expression+‘Let's proceed with this proposal,’” and example outputs are “anger: 0.92” or “joy: 0.80.” When the emotion score is heightened, the storage unit automatically applies display methods to stored data (e.g., background color change, font size enlargement, animation addition, highlight frame display, etc.) so that users can intuitively grasp information that requires attention. When emotions are calm, the storage unit maintains the normal display format (e.g., standard colors, standard font size), and when emotions are unstable, it dynamically recalculates the display method according to the fluctuation range of emotion scores and the emotional tendency of each utterance, maintaining consistency and comfort in the user experience. When emotions are positive, the storage unit automatically applies bright colors (e.g., yellow, green, etc.), and when negative, dark colors (e.g., red, gray, etc.). As an example of AI model input/output, the input is “multimodal data of audio, image, and text plus stored data,” and the output is “stored data with emotion scores, emotion labels, and display method specifications.” In subsequent processing, the stored data is linked to the history management unit or display unit when resuming, allowing users to immediately confirm highlighted or normal displays according to emotions. Unlike conventional subjective emotion judgment by humans or manual adjustment of display formats, the storage unit combines computer-specific technical approaches such as multimodal emotion estimation in high-dimensional feature space, complex emotion analysis using deep learning models, and real-time control of display methods, thereby achieving technical effects such as optimization of stored data display according to emotions and improvement of user experience. Specific application fields include highlighted storage display of urgent topics in corporate online meetings, emphasis of key points according to students' emotional changes in educational settings, highlighted storage display of important matters based on emotional exchanges between patients and doctors in remote medical conferences, highlighted storage of discussion points based on emotion analysis in policy-making workshops, and emotion-highlighted history storage functions in AI-based automatic minutes generation services.

The following is a brief description of the processing flow of Example of the Embodiment. Specifically, the present system realizes a pipeline-type data flow that links multiple AI models, natural language processing technologies, web technologies, and database technologies from acquisition of conversation data to analysis, display, visualization, and storage. The system receives 16 kHz, 16 bit, monaural PCM format audio data at the speech recognition unit, and generates utterance-level text data using deep learning-based speech recognition models (e.g., CTC-based RNN, Transformer-type speech recognition models, etc.). The analysis unit receives the text data and applies natural language processing modules such as morphological analysis, syntactic analysis, semantic analysis, topic extraction, and emotion estimation in a pipeline manner to extract and aggregate features such as speaker attributes, speaking frequency, topic importance, and emotion scores. The system generates structured analysis result data (e.g., number of utterances and speaking time per speaker, importance scores per topic, key points with emotion labels, etc.) and sequentially transmits it to the display unit, visualization unit, and storage unit. The display unit draws the received analysis results as tables or graphs using HTML5, CSS3, JavaScript, etc., and dynamically applies color schemes, fonts, layouts, animations, etc., according to user settings and emotion scores. The visualization unit receives topic-classified data and progress data as input, automatically selects the optimal visualization method for each topic (e.g., bar graphs, pie charts, line graphs, network diagrams, etc.), and draws them in real time. The storage unit stores analysis results and visualization data in NoSQL-type databases or time-series DBs, and automatically adjusts storage priority and display methods according to emotion scores and topic importance. The system also realizes data linkage with external applications (e.g., schedule management, project management, messaging, etc.) using API integration functions. Through this series of processing flows, the system achieves computer-specific technical improvements such as high-dimensional feature extraction by AI models, dynamic priority control, real-time information presentation, diverse visualization, and flexible storage management, which are different from conventional human work or simple automation, and exerts technical effects such as significant improvement in discussion efficiency, information searchability, and user experience. Specific application fields include corporate online meetings, discussion classes in educational settings, medical conferences, policy-making workshops, and AI-based automatic minutes generation services.

Step 1: The analysis unit analyzes conversation content in real time. The analysis unit uses speech recognition technology to convert conversation into text, and then uses natural language processing technology to analyze the text-converted conversation content. The speech recognition technology uses deep learning-based speech recognition algorithms to convert audio data of the conversation into text data. The natural language processing technology includes morphological analysis, grammatical analysis, semantic analysis, and analyzes the text data to output analysis results. Step 2: The display unit displays the content analyzed by the analysis unit in a tabular format. The display unit extracts content of Pattern A and Pattern B and creates tables using HTML and CSS. The display unit receives analysis results as input and outputs tables. Step 3: The visualization unit visualizes the progress of a discussion. The visualization unit creates graphs for each discussion topic and visually indicates how much each topic has been discussed. The visualization unit uses bar graphs, pie charts, line graphs, etc., and receives analysis results as input to output graphs. Step 4: The storage unit stores the history of the discussion. The storage unit stores the history of the discussion in a database and provides information for resuming later. The storage unit receives analysis results as input and outputs stored data. Specifically, in Step 1, the system receives 16 kHz, 16 bit, monaural PCM format audio data at the speech recognition unit, and generates utterance-level text data using deep learning models such as CTC-based RNN and Transformer-type speech recognition models. The analysis unit receives the text data and applies natural language processing modules such as morphological analysis, syntactic analysis, semantic analysis, topic extraction, and emotion estimation in a pipeline manner to extract and aggregate features such as speaker attributes, speaking frequency, topic importance, and emotion scores. The analysis unit generates structured analysis result data (e.g., number of utterances and speaking time per speaker, importance scores per topic, key points with emotion labels, etc.) and sequentially transmits it to the display unit, visualization unit, and storage unit. In Step 2, the display unit draws the received analysis results as tables or graphs using HTML5, CSS3, JavaScript, etc., and dynamically applies color schemes, fonts, layouts, animations, etc., according to user settings and emotion scores. Extraction of Pattern A and Pattern B content is realized by conditional branching and filtering processing (e.g., topic classification, emotion label determination, etc.) from the analysis result data. In Step 3, the visualization unit receives topic-classified data and progress data as input, automatically selects the optimal visualization method for each topic (e.g., bar graphs, pie charts, line graphs, network diagrams, etc.), and draws them in real time. For graph generation, libraries such as WebGL and D3.js are utilized, and dynamic application of color coding, animation, highlighting, etc., is performed. In Step 4, the storage unit stores analysis results and visualization data in NoSQL-type databases or time-series DBs, and automatically adjusts storage priority and display methods according to emotion scores and topic importance. The stored data is immediately provided to the history management unit or analysis unit/display unit when resuming. Through this series of steps, the system achieves computer-specific technical improvements such as high-dimensional feature extraction by AI models, dynamic priority control, real-time information presentation, diverse visualization, and flexible storage management, and exerts technical effects such as significant improvement in discussion efficiency, information searchability, and user experience. Specific application fields include corporate online meetings, discussion classes in educational settings, medical conferences, policy-making workshops, and AI-based automatic minutes generation services.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described analysis unit, display unit, visualization unit, and storage unit is implemented by at least one of, for example, a smart device 14 and a data processing apparatus 12. For example, the analysis unit is implemented by a processor 46 of the smart device 14 and a processor 28 of the data processing apparatus 12, converts conversation into text using speech recognition technology, and analyzes the text-converted conversation content using natural language processing technology. The display unit is implemented by, for example, a display 40A of the smart device 14 and a specific processing unit 290 of the data processing apparatus 12, and displays the analyzed content in a tabular format. The visualization unit is implemented by, for example, a display 40A of the smart device 14 and a specific processing unit 290 of the data processing apparatus 12, and visualizes the progress of a discussion using graphs or the like. The storage unit is implemented by, for example, a storage 50 of the smart device 14 and a database 24 of the data processing apparatus 12, and stores the history of the discussion. The correspondence between each unit and the device or control unit is not limited to the above examples, and various modifications are possible.

### Second Embodiment

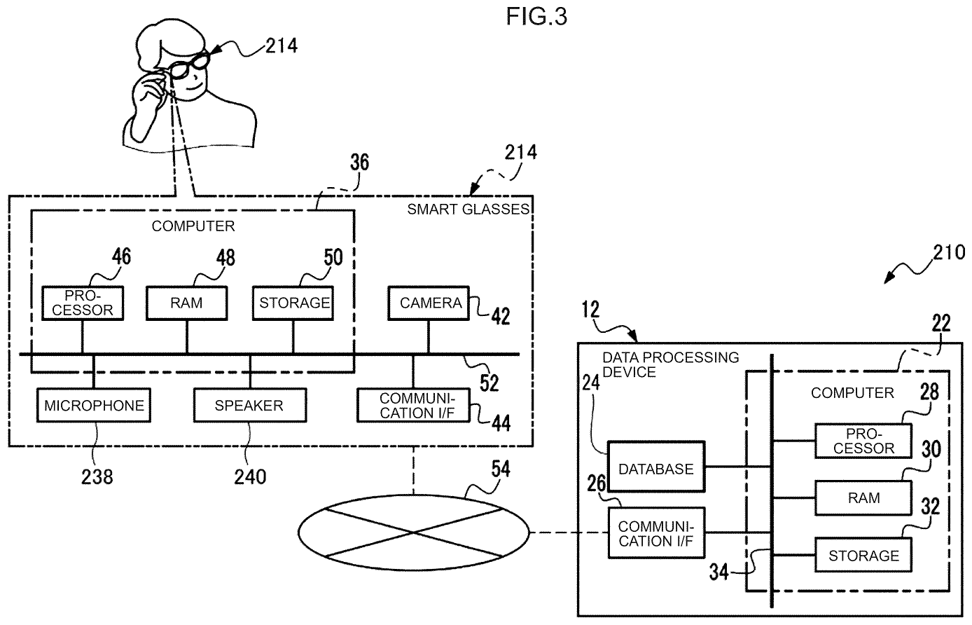

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

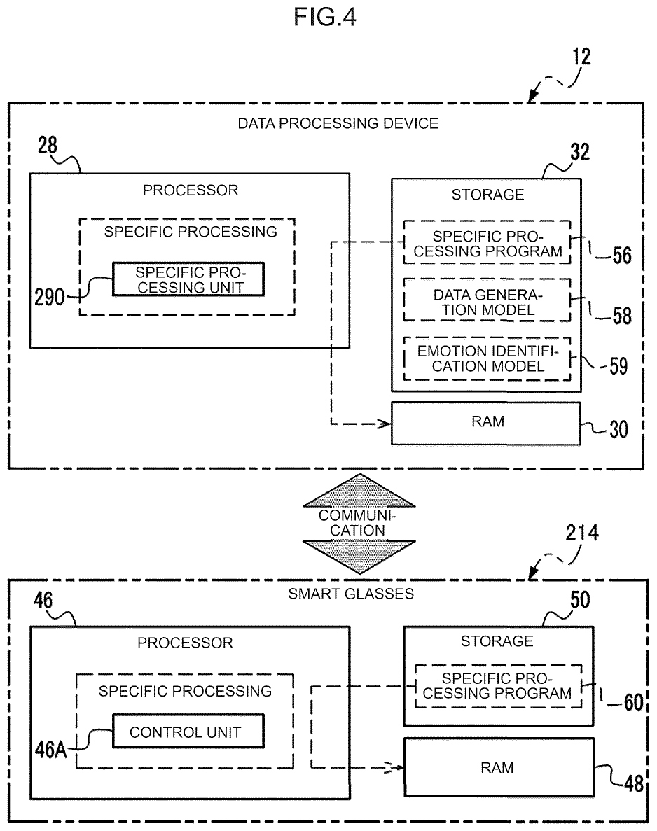

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described analysis unit, display unit, visualization unit, and storage unit is implemented by at least one of, for example, smart glasses 214 and a data processing apparatus 12. For example, the analysis unit is implemented by a processor 46 of the smart glasses 214 and a processor 28 of the data processing apparatus 12, converts conversation into text using speech recognition technology, and analyzes the text-converted conversation content using natural language processing technology. The display unit is implemented by, for example, a display of the smart glasses 214 and a specific processing unit 290 of the data processing apparatus 12, and displays the analyzed content in a tabular format. The visualization unit is implemented by, for example, a display of the smart glasses 214 and a specific processing unit 290 of the data processing apparatus 12, and visualizes the progress of a discussion using graphs or the like. The storage unit is implemented by, for example, a storage 50 of the smart glasses 214 and a database 24 of the data processing apparatus 12, and stores the history of the discussion. The correspondence between each unit and the device or control unit is not limited to the above examples, and various modifications are possible.

### Third Embodiment

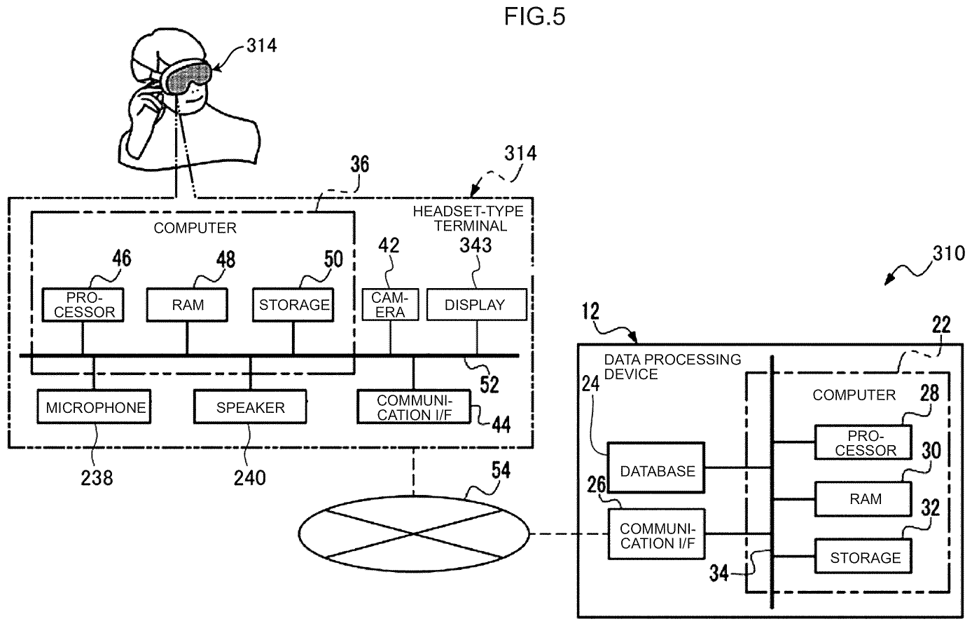

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

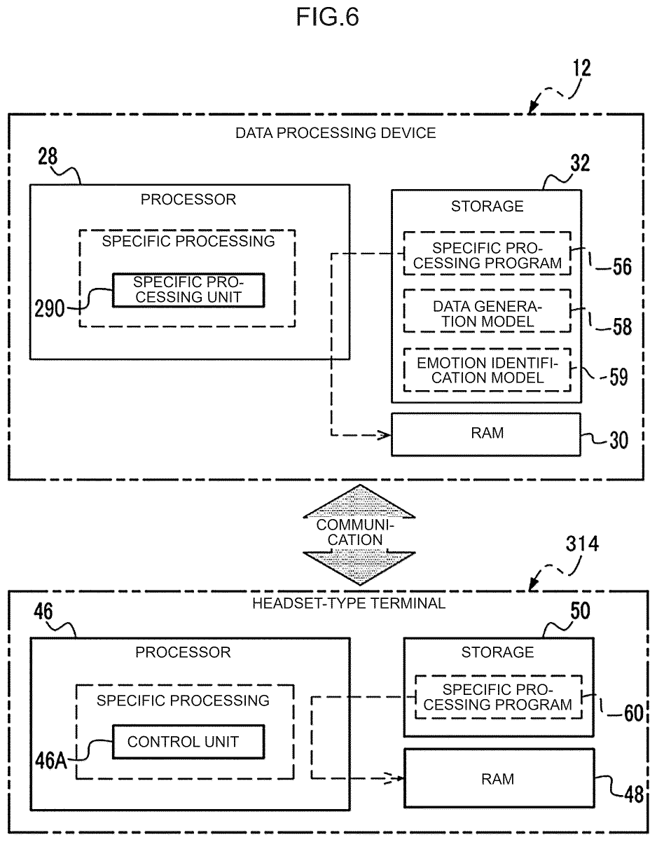

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described analysis unit, display unit, visualization unit, and storage unit is implemented by at least one of, for example, a headset-type terminal 314 and a data processing apparatus 12. For example, the analysis unit is implemented by a processor 46 of the headset-type terminal 314 and a processor 28 of the data processing apparatus 12, converts conversation into text using speech recognition technology, and analyzes the text-converted conversation content using natural language processing technology. The display unit is implemented by, for example, a display 343 of the headset-type terminal 314 and a specific processing unit 290 of the data processing apparatus 12, and displays the analyzed content in a tabular format. The visualization unit is implemented by, for example, a display 343 of the headset-type terminal 314 and a specific processing unit 290 of the data processing apparatus 12, and visualizes the progress of a discussion using graphs or the like. The storage unit is implemented by, for example, a storage 50 of the headset-type terminal 314 and a database 24 of the data processing apparatus 12, and stores the history of the discussion. The correspondence between each unit and the device or control unit is not limited to the above examples, and various modifications are possible.

### Fourth Embodiment

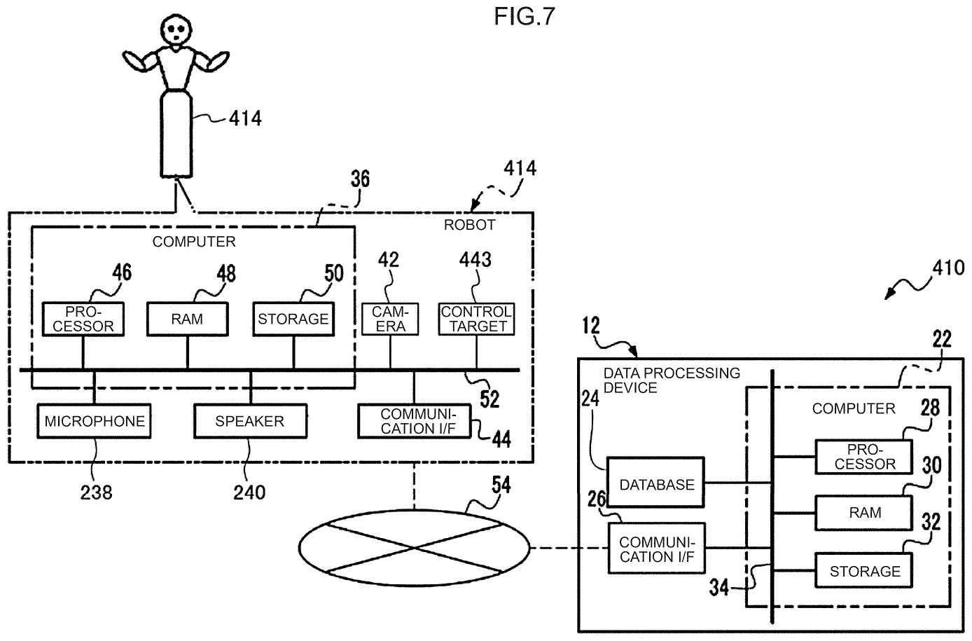

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

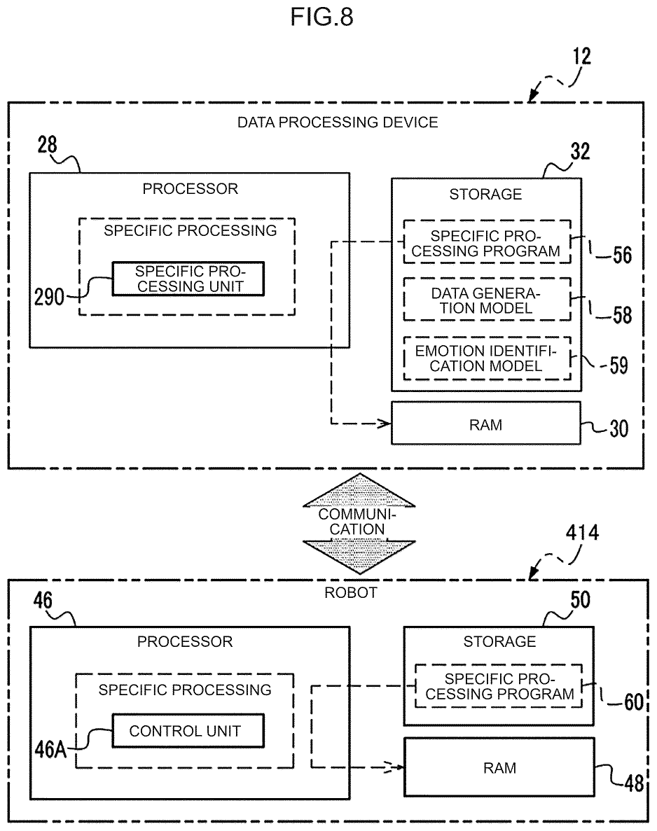

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described analysis unit, display unit, visualization unit, and storage unit is implemented by at least one of, for example, a robot 414 and a data processing apparatus 12. For example, the analysis unit is implemented by a processor 46 of the robot 414 and a processor 28 of the data processing apparatus 12, converts conversation into text using speech recognition technology, and analyzes the text-converted conversation content using natural language processing technology. The display unit is implemented by, for example, a display of the robot 414 and a specific processing unit 290 of the data processing apparatus 12, and displays the analyzed content in a tabular format. The visualization unit is implemented by, for example, a display of the robot 414 and a specific processing unit 290 of the data processing apparatus 12, and visualizes the progress of a discussion using graphs or the like. The storage unit is implemented by, for example, a storage 50 of the robot 414 and a database 24 of the data processing apparatus 12, and stores the history of the discussion. The correspondence between each unit and the device or control unit is not limited to the above examples, and various modifications are possible.

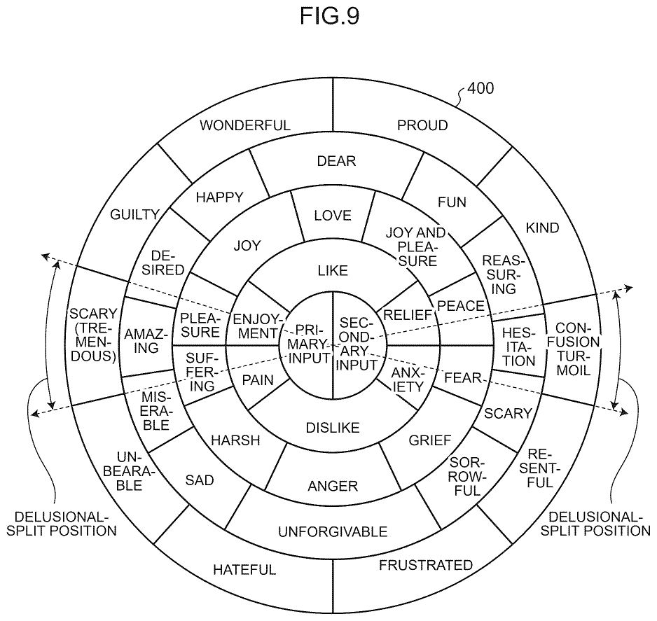

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

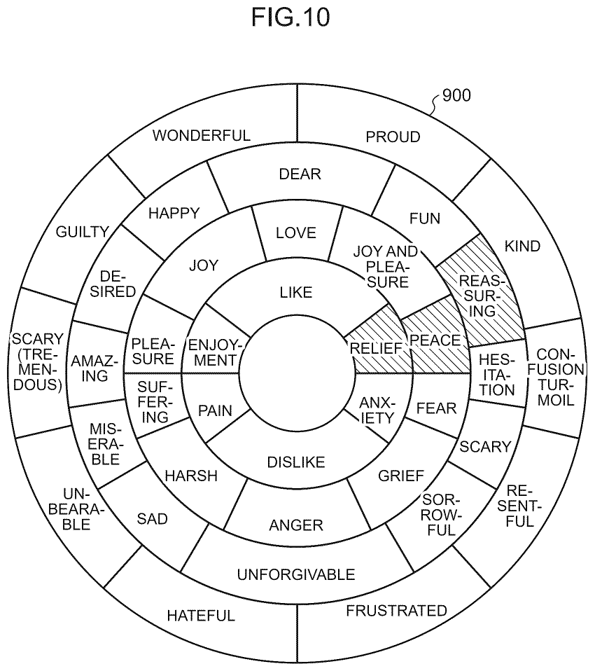

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1)A system comprising: an analysis unit configured to analyze conversation content in real time; a display unit configured to display the content analyzed by the analysis unit in a tabular format; a visualization unit configured to visualize the progress of a discussion; and a storage unit configured to store the history of the discussion.
(Supplementary Note 2)The system according to Supplementary Note 1, wherein the analysis unit is configured to convert conversation into text using speech recognition technology.
(Supplementary Note 3)The system according to Supplementary Note 1, wherein the analysis unit is configured to analyze the text-converted conversation content using natural language processing technology.
(Supplementary Note 4)The system according to Supplementary Note 1, wherein the display unit is configured to extract different patterns of content and display them in a tabular format.
(Supplementary Note 5)The system according to Supplementary Note 1, wherein the visualization unit is configured to create graphs for each discussion topic and visually indicate how much each topic has been discussed.
(Supplementary Note 6)The system according to Supplementary Note 1, wherein the storage unit is configured to store the history of the discussion and provide information for resuming the discussion later.
(Supplementary Note 7)The system according to Supplementary Note 1, wherein the analysis unit is configured to estimate emotions in the conversation and adjust the accuracy of analysis based on the estimated emotions.
(Supplementary Note 8)The system according to Supplementary Note 1, wherein the analysis unit is configured to understand the context of the conversation and automatically highlight important keywords.
(Supplementary Note 9)The system according to Supplementary Note 1, wherein the analysis unit is configured to update analysis results in real time according to the progress of the conversation.
(Supplementary Note 10)The system according to Supplementary Note 1, wherein the analysis unit is configured to estimate emotions in the conversation and adjust the display method of analysis results based on the estimated emotions.
(Supplementary Note 11)The system according to Supplementary Note 1, wherein the analysis unit is configured to refer to background information of the conversation and automatically add related information.
(Supplementary Note 12)The system according to Supplementary Note 1, wherein the analysis unit is configured to customize analysis results based on attribute information of participants in the conversation.
(Supplementary Note 13)The system according to Supplementary Note 1, wherein the display unit is configured to estimate emotions in the conversation and determine the priority of display content based on the estimated emotions.
(Supplementary Note 14)The system according to Supplementary Note 1, wherein the display unit is configured to customize display content according to the user's visual preferences.
(Supplementary Note 15)The system according to Supplementary Note 1, wherein the display unit is configured to update display content in real time and reflect the latest information.
(Supplementary Note 16)The system according to Supplementary Note 1, wherein the display unit is configured to estimate emotions in the conversation and change the display format based on the estimated emotions.
(Supplementary Note 17)The system according to Supplementary Note 1, wherein the display unit is configured to optimize display content for the user's device.
(Supplementary Note 18)The system according to Supplementary Note 1, wherein the display unit is configured to display content in cooperation with other applications.
(Supplementary Note 19)The system according to Supplementary Note 1, wherein the visualization unit is configured to estimate emotions in the conversation and adjust the visualization method based on the estimated emotions.
(Supplementary Note 20)The system according to Supplementary Note 1, wherein the visualization unit is configured to visualize the progress of the discussion in real time and highlight important points.
(Supplementary Note 21)The system according to Supplementary Note 1, wherein the visualization unit is configured to apply different visualization methods for each discussion topic.
(Supplementary Note 22)The system according to Supplementary Note 1, wherein the visualization unit is configured to estimate emotions in the conversation and determine the priority of visualization based on the estimated emotions.
(Supplementary Note 23)The system according to Supplementary Note 1, wherein the visualization unit is configured to optimize visualization content for the user's device.
(Supplementary Note 24)The system according to Supplementary Note 1, wherein the visualization unit is configured to display visualization content in cooperation with other applications.
(Supplementary Note 25)The system according to Supplementary Note 1, wherein the storage unit is configured to estimate emotions in the conversation and determine the priority of data to be stored based on the estimated emotions.
(Supplementary Note 26)The system according to Supplementary Note 1, wherein the storage unit is configured to associate stored data with the user's past discussion history.
(Supplementary Note 27)The system according to Supplementary Note 1, wherein the storage unit is configured to update stored data in real time and reflect the latest information.
(Supplementary Note 28)The system according to Supplementary Note 1, wherein the storage unit is configured to estimate emotions in the conversation and adjust the display method of stored data based on the estimated emotions.
(Supplementary Note 29)The system according to Supplementary Note 1, wherein the storage unit is configured to optimize stored data for the user's device.
(Supplementary Note 30)The system according to Supplementary Note 1, wherein the storage unit is configured to store data in cooperation with other applications.

What is claimed is:

1. A system comprising:
circuitry configured to:
receive, from a client terminal via a packet-switched network, audio data representing a voice captured by a microphone of the client terminal;
convert the audio data into text data by extracting acoustic feature vectors comprising mel-frequency cepstral coefficients from the audio data and inputting the acoustic feature vectors into a speech recognition model comprising at least one of a convolutional neural network or a recurrent neural network;
analyze the text data by inputting the text data into a natural language processing model comprising a Transformer-based architecture to extract at least one of a keyword, a topic label, or a comparison structure from the text data;
estimate an emotion based on the audio data by inputting the audio data into an emotion identification model to generate an emotion score;
generate, based on the extracted keyword or topic label and the emotion score, visualization data comprising parameters for rendering at least one of a table or a graph; and
transmit the visualization data to the client terminal via the packet-switched network, the visualization data causing the client terminal to display a visual representation of the text data.

2. The system according to claim 1, wherein the speech recognition model comprises a hybrid model combining the convolutional neural network and the recurrent neural network, and wherein converting the audio data comprises applying a connectionist temporal classification loss function to determine an optimal character string sequence.

3. The system according to claim 1, wherein the natural language processing model comprises a pre-trained large-scale language model, and wherein analyzing the text data comprises performing at least one of morphological analysis, syntactic analysis using dependency parsing, or semantic analysis using contextual embedding to generate a context vector.

4. The system according to claim 1, wherein the circuitry is further configured to extract the comparison structure by detecting a comparison expression pattern in the text data using a rule-based pattern matcher or a classifier model based on the Transformer-based architecture, and to generate structured data comprising item labels and value pairs for rendering in the table.

5. The system according to claim 1, wherein the emotion identification model comprises a multimodal emotion estimation model combining at least one of a multilayer perceptron, the convolutional neural network, or the recurrent neural network, and wherein the emotion score comprises at least one of a positive score, a negative score, or a neutral score.

6. The system according to claim 1, wherein the circuitry is further configured to adjust an accuracy parameter of the speech recognition model based on the emotion score, such that when the emotion score indicates heightened emotion, the circuitry applies a high-precision analysis mode, and when the emotion score indicates calm emotion, the circuitry applies a normal analysis mode.

7. The system according to claim 1, wherein the circuitry is further configured to extract important keywords from the text data by applying at least one of a term frequency-inverse document frequency score calculation, an attention weight analysis, or a keyword classifier using the Transformer-based architecture, and to generate highlighting metadata for the extracted important keywords.

8. The system according to claim 1, wherein the visualization data comprises at least one of a bar graph indicating a number of utterances per topic, a pie chart indicating a distribution of time per topic, or a network diagram indicating relationships between speakers.

9. The system according to claim 1, wherein the circuitry is further configured to determine a priority of the visualization data based on the emotion score, such that when the emotion score indicates heightened emotion, visualization data associated with important information is transmitted with a higher priority.

10. The system according to claim 1, wherein the circuitry is further configured to adjust a display format of the visualization data based on the emotion score, such that when the emotion score indicates heightened emotion, the circuitry generates a highlight format comprising at least one of a background color change, a font size enlargement, or an animation effect.

11. The system according to claim 1, wherein the circuitry is further configured to receive attribute information of a participant from the client terminal, the attribute information comprising at least one of a position, a department, or an area of expertise, and to customize the visualization data based on the attribute information.

12. The system according to claim 1, wherein the circuitry is further configured to measure a frequency of utterances and a duration of utterances for each participant based on the text data, calculate a balance score indicating a degree of bias in utterances, and generate an alert flag when the balance score exceeds a threshold.

13. The system according to claim 1, wherein the circuitry is further configured to calculate an importance score for each topic extracted from the text data by synthesizing at least one of an utterance count, an utterance duration, a keyword frequency, or the emotion score, and to adjust a rendering priority of the visualization data based on the importance score.

14. The system according to claim 1, wherein the circuitry is further configured to search an external knowledge base using a keyword extracted from the text data, and to generate annotation data comprising a link to related information retrieved from the external knowledge base.

15. The system according to claim 1, wherein the circuitry is further configured to store the text data and the visualization data in a database in chronological order, and to retrieve stored data from the database in response to a resumption request received from the client terminal.

16. The system according to claim 15, wherein the circuitry is further configured to determine a storage priority based on the emotion score, such that when the emotion score indicates heightened emotion, data associated with important information is stored with a higher priority.

17. The system according to claim 1, wherein the circuitry is further configured to transmit the visualization data to an external application via an application programming interface, the external application comprising at least one of a schedule management application, a project management application, or a messaging application.

18. A system comprising:
a communication interface configured to communicate, via a packet-switched network conforming to at least one of a 5G, Wi-Fi, or Bluetooth communication standard, with a client terminal comprising a microphone, a speaker, a camera having a CMOS image sensor, a touch panel, and a display;
a processor;
a random-access memory;
a memory storing a speech recognition model comprising at least one of a convolutional neural network or a recurrent neural network, a natural language processing model comprising a Transformer-based architecture, an emotion identification model, and a data generation model obtained by deep learning on a neural network;
a database; and
circuitry configured to:
receive, from the client terminal via the communication interface, audio data representing a voice captured by the microphone of the client terminal;
convert the audio data into text data by extracting acoustic feature vectors comprising mel-frequency cepstral coefficients from the audio data and inputting the acoustic feature vectors into the speech recognition model;
analyze the text data by inputting the text data into the natural language processing model to extract at least one of a keyword, a topic label, or a comparison structure from the text data;
estimate an emotion based on at least one of the audio data or image data captured by the camera by inputting the audio data or the image data into the emotion identification model to generate an emotion score and an emotion label;
store the text data and the emotion score in the database in chronological order;
generate, based on the extracted keyword or topic label and the emotion score, visualization data comprising parameters for rendering at least one of a table, a bar graph, a pie chart, or a network diagram;
adjust at least one of a display format, a rendering priority, or a level of detail of the visualization data based on the emotion score; and
transmit the visualization data to the client terminal via the communication interface, the visualization data causing the client terminal to display a visual representation of the text data via the display.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system, the method comprising:
receiving, from a client terminal via a packet-switched network, audio data representing a voice captured by a microphone of the client terminal;
converting the audio data into text data by extracting acoustic feature vectors comprising mel-frequency cepstral coefficients from the audio data and inputting the acoustic feature vectors into a speech recognition model comprising at least one of a convolutional neural network or a recurrent neural network;
analyzing the text data by inputting the text data into a natural language processing model comprising a Transformer-based architecture to extract at least one of a keyword, a topic label, or a comparison structure from the text data;
estimating an emotion based on the audio data by inputting the audio data into an emotion identification model to generate an emotion score;
generating, based on the extracted keyword or topic label and the emotion score, visualization data comprising parameters for rendering at least one of a table or a graph; and
transmitting the visualization data to the client terminal via the packet-switched network, the visualization data causing the client terminal to display a visual representation of the text data.
